(19) United States
(12) Patent Application Publication
(10) Pub. No.: US 2009/0278869 A1
(43) Pub. Date: Nov. 12, 2009

(54) Display Device

(76) Inventors: Yoshihisa Oishi, Kawasaki (JP); Hiroyuki Nitta, Kawasaki (JP); Junichi Maruyama, Kawasaki (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/913,963

(22) PCT Filed: May 10, 2006
(86) PCT No.: PCT/JP2006/309770

§ 371 Date: Dec. 17, 2008

(30) Foreign Application Priority Data
May 11, 2005 (JP) 2005-137986
Jul. 29, 2005 (JP) 2005-219899

(51) Int. Cl. G09G 5/10

(52) U.S. Cl. 345/691; 345/690; 345/209

(57) ABSTRACT

A one-frame interval is divided into a light field interval and a dark field interval. In the light field interval, the display data of high tones is displayed, while in the dark field interval, the display data of low tones is displayed. This divisional display makes it possible to pseudoly display the tones of the input display data. Then, in a case that the tones of the input display data is on the lower tone side, the display data of the dark field is set to the corresponding minimum tone with the minimum luminance, while in a case that the tone of the input display data is on the higher tone side, the display data of the light field is set to the corresponding maximum tone with the maximum luminance.

### INCORPORATION BY REFERENCE

The present application claims priorities from Japanese applications JP2005-137986 filed on May 11, 2005, JP2005-219899 filed on Jul. 29, 2005, the contents of which are hereby incorporated by reference into this application.

### TECHNICAL FIELD

The present invention relates to a hold-type display device such as a liquid crystal display device, an organic EL (Electro Luminescence) display and a LCOS (Liquid Crystal On Silicon) display, and more particularly to the display device which is suitable to displaying a moving image.

### BACKGROUND ART

If a general display device is classified from a viewpoint of a moving-image display, the display device is roughly classified into an impulse response display and a hold response display. The impulse response display means a display type in which a luminance response is lowering immediately after scanning as is shown in the afterglow characteristic of a CRT. The hold response display means a display type in which the luminance according to the display data is kept until the next scan as is shown in the characteristic of the liquid crystal display.

The relevant technical documents are indicated as follows:

Patent Publication 1: Official Gazette of JP-A 2005-6275 (U.S. Patent Publication No. 2004/101058)

Patent Publication 2: Official Gazette of JP-A-2003-280599 (U.S. Patent Publication No. 2004/001054)

Patent Publication 3: Official Gazette of JP-A-2003-50569 (U.S. Patent Publication No. 2002/067332)

Patent Publication 4: Official Gazette of JP-A-2004-240317 (U.S. Patent Publication No. 2004/155847)

Non-patent Publication 1: Moving Picture Quality Improvement for Hold-type AM-LCDs, Taiichiro kurita, SID01 DIGEST

The hold-type response display device is characterized in that an excellent display with no flicker is displayed if a still image is displayed, while a peripheral portion of an object of a moving object is viewed as being blurred, that is, the so-called moving-picture blurredness (hereafter, often referred to as “blurredness of a moving image”) takes place. That is, for a moving image, this type display device has a disadvantage that the quality of the display is made remarkably lower. The occurrence factor of this moving-picture blurredness is laid in the so-called retina afterimage caused by the viewer's interpolation of the display images before and after the movement with respect to the display image whose luminance is held when a viewer moves his or her line of sight with movement of an object. Hence, however the response speed of the display may be improved, the blurredness of a moving image is not completely eliminated. For solving this blurredness, it is effective to use the method of making the hold-type response display closer to the impulse-type response display by updating the display image with a shorter frequency or temporarily canceling an afterimage on a retina by inserting a black image. (See the non-paten publication 1.)

On the other hand, the representative display device that is required to display a moving image is a TV receiver set. The scanning frequency of the TV is a normalized signal. For example, it is an interlaced scan of 60 Hz for the NTSC signal or a sequential scan of 50 Hz for the PAL signal. In a case that the frame frequency of the display image generated on this frequency ranges from 60 Hz to 50 Hz, the moving image on the display is made blurred because of a relatively low frequency.

For improving the blurred moving image, a technology of updating the image with a shorter frequency as that indicated above may be referred as described above. As this technology, it is possible to use the method of generating display data of an interpolation frame based on the display data between the adjacent frames and enhancing the update speed of the image with the interpolation frame. (See the patent publication 1.)

As a technology of inserting the black frame (black image, it is possible to refer to the technology of inserting the black display data between the display data on the adjacent frames (abbreviated as the black display data inserting system) (see the Patent Publication 2) or the technology of repetitively turning on and off the backlight (abbreviated as the blink backlight system). (See the Patent Publication 3).

Further, as another technology of inserting the black image, it is possible to use the method of splitting a one-frame interval into a first interval and a second one, making the pixel data to be written on the pixels in the one-frame interval doubled in the first split interval in a manner not to lower the luminance of the overall image, concentratively write the pixel data in the first interval, and write the remaining pixel data in the second interval only if the doubled data exceeds the displayable range in the first interval. This method thus makes the change of the display luminance of the hold-type response display closer to that of the impulse-type response display, thereby allowing the visibility of the moving image to be improved. (See the Patent Publication 4.)

### SUMMARY OF THE INVENTION

By applying the foregoing technologies to the display device, the blurred moving image on the display may be improved. However, it is known that the application of the foregoing technologies brings about the following disadvantages.

As to the system of generating the interpolation frame as described in the Patent Publication 1, this method is arranged to generate the display data that does not exist in itself. Hence, the generation of more accurate data results in increasing the circuit in scale. Conversely, the suppression of the circuit scale results in bringing about an error in the interpolation, thereby remarkably lowering the display quality.

On the other hand, the system of inserting the black frame as described in the Patent Publications 2 and 3, in principle, does not bring about an error in the interpolation and is more advantageous in light of the circuit scale than the method of generating the interpolation frame. However, the black data inserting system or the blink backlight system makes the display luminance in all the tones lower by the black frame. For compensating for the lowered luminance, as to the black data inserting system, it is possible to raise the luminance of the backlight. This results in increasing the power consumption according to the raised luminance and requiring a massive work for coping with the heat caused by the rise of the luminance. Further, the increase of an absolute value of light leakage on the black display also results in lowering the contrast. Turning to the blink backlight system, large current is required for shifting the non-lit state into the lit state or the coloring on the display is brought about by the difference of the response speeds of visual rays resulting from the variety of fluorescent materials.

Turning to the black image inserting system described in the Patent Publication 4, though this system is effective in the impulse type response by the black image insertion, this system serves to merely make the display data doubled in the first interval if one frame is halved or make the display data in the first interval N times if one frame is split into N frames. This means that this system does not consider a voltage applied onto the liquid crystal, a luminance characteristic, and a liquid crystal response speed characteristic. Hence, this system does not offer a target tone characteristic (γ characteristic) of the display, thereby making the image quality degraded. Further, this system merely allows image to be displayed by speeding up the display frequency, that is, splitting one frame into two or more fields. That means that this system merely makes the display frequency twice or more as fast and does not consider enhancement of the liquid crystal response speed. Hence, this system makes the luminance lower and does not reach the target tone characteristic (γ characteristic), thereby making the image quality degraded. Moreover, this system does not consider the respect of reducing the capacity of a frame memory that holds the display data. This also means that the display device to which this system is applied has difficulty in lowering the manufacturing cost.

It is an object of the present invention to provide a display device which is arranged to reduce the blurredness of the moving image as suppressing reduction of a luminance and a contrast, degrade of a tone characteristic, increase of power consumption required for light emission, increase of a circuit like a frame memory and so forth.

The present invention is arranged to pseudoly display the tones required by the external system by causing each pixel to display plural tones. Further, in a case that the tones required by the external system range from the intermediate tones to low ones, at least one of plural tones is made to be the minimum tone (minimum luminance), while in a case that the tones required by the external system range from the intermediate tones to the high ones, at least one of those tones is made to be the maximum tone (maximum luminance). That is, in a case that the tones required by the external system are on the lower tone side, by switching the minimum tone with the predetermined tone, the tones required by the internal system are pseudoly displayed.

On the other hand, in a case that the tones required by the external system are on the higher tone sides, by switching the maximum tone with the predetermined tone, the tones required by the external system are pseudoly displayed. Further, for those tones, a means of converting the display data is provided which means considers a voltage applied on the pixels, the luminance characteristic, and the response speed characteristic of the pixels. Moreover, a means of correcting data is provided which means operates to speed up the pixel response. Moreover, a means of selecting a scan is provided which means allows a scan to be alternately selected for the display data of plural fields.

According to an aspect of the present invention, the display device is arranged not to insert a black tone independently of the tones required by the external system but switch the minimum tone with the predetermined tone if the tones required by the external are laid on the lower tone side when an image is displayed. Hence, the display device operates to pseudoly display the tones required by the external system by switching the maximum tone with the predetermined tone if the tones required by the external system are laid on the higher tone side. The display device thus provides a capability of reducing the blurredness of a moving image as suppressing reduction of a luminance and a contrast and increase of power consumption required for light emission. That is, for the lower luminance (the lower tone side), the display device is easy to recognize the blurredness of the moving image. By inserting the minimum tone, therefore, the blurredness of the moving image is reduced. On the other hand, for the higher luminance (the higher tone side), the display device has difficulty in recognizing the blurredness of the moving image. By enhancing the lower tone to be inserted, therefore, the reduction of a luminance and a contrast is suppressed.

According to another aspect of the present invention, the display device provides a capability of reducing the blurredness of a moving image as suppressing degrade of a tone characteristic, increase of power consumption required for light emission and increase of a circuit like a frame memory in scale.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing images of a light field, a dark field and a display luminance;

FIG. 2 is a block diagram showing an arrangement of a liquid crystal display device according to a first to a third embodiments of the present invention;

FIG. 3 is a circuit diagram showing an arrangement of a conversion table;

FIG. 4 is a table showing an example of the conversion table;

FIG. 5 is a view showing an I/O timing specification;

FIG. 6 is a view showing a liquid crystal driving waveform of a two-field alternating current system;

FIG. 7 is a view showing a combination of a two-field alternating current system and a three-field alternating current system;

FIG. 8 is a view showing a combination of a two-field alternating current system and a one-field alternating current system;

FIG. 9 is a graph showing relation between a voltage V applied onto liquid crystal V and a static luminance T in a liquid crystal display panel;

FIG. 10 is a graph showing relation between liquid crystal driving data D and a voltage V applied onto liquid crystal;

FIG. 11A is a graph showing a data conversion characteristic in the first embodiment and FIG. 11B is a table showing the data conversion characteristic.

FIG. 12 is a graph showing a luminance response waveform of the liquid crystal display panel;

FIGS. 13A and 13B are tables showing MPRT measured results;

FIG. 14 is a graph showing a data conversion characteristic in the second embodiment;

FIG. 15 is a graph showing a data conversion characteristic in the third embodiment;

FIG. 16 is a block diagram showing an arrangement of a liquid crystal display device according to a fourth to a sixth embodiments of the present invention;

FIG. 17 is a graph showing a data conversion characteristic in the fourth embodiment;

FIG. 18 is a graph showing a luminance response waveform on an intermediate tone display on a higher tone side in the fourth embodiment;

FIG. 19 is a graph showing a data conversion characteristic in the fifth embodiment;

FIG. 20 is a graph showing a data conversion characteristic in the sixth embodiment;

FIG. 21 is a block diagram showing an arrangement of a liquid crystal display device according to a seventh embodiment of the present invention;

FIG. 22 is a graph showing a data conversion characteristic in the seventh embodiment;

FIG. 23A shows a light field conversion table in the seventh embodiment, while FIG. 23B shows a dark field conversion table in the seventh embodiment;

FIG. 24 shows a timing specification in the seventh embodiment;

FIG. 25 shows a luminance response waveform in the seventh embodiment;

FIG. 26 shows scan selection in the prior art;

FIG. 27 shows scan selection of the first to the seventh embodiments;

FIG. 28 shows memory control timings of the first to the sixth embodiments;

FIG. 29 shows a memory control timing of the seventh embodiment;

FIG. 30 shows scan selection of an eighth embodiment of the present invention;

FIG. 31 shows a scan selection timing of the eighth embodiment;

FIG. 32 shows a memory control timing of the eighth embodiment;

FIG. 33 shows another memory control timing of the eighth embodiment;

FIG. 34 is a circuit diagram showing an arrangement of a driving circuit included in the eighth embodiment;

FIG. 35 is a circuit diagram showing an arrangement of a scan driver circuit included in the eighth embodiment;

FIG. 36 shows a scan driver control timing of the eighth embodiment;

FIG. 37 shows a scan selection timing of a ninth embodiment of the present invention;

FIG. 38 is a circuit diagram showing an arrangement of a scan driver circuit included in the ninth embodiment;

FIG. 39 shows a scan driver control timing of the ninth embodiment;

FIG. 40 shows a horizontal timing of a tenth embodiment of the present invention;

FIG. 41 shows a scan selection of the tenth embodiment; and

FIG. 42 shows a scan selection of the tenth embodiment.

### BEST MODES FOR CARRYING OUT THE INVENTION

Hereafter, throughout the specification, an interval of one screen to be inputted from an external system is specified as a one-frame interval, and an interval during which all the scan lines are selected for a display panel is defined as a one-field interval. In a commonly available display device, therefore, a one-frame interval is made equal to a one-field interval.

In the display device, the luminance obtained by repeating the scan when the display data remains static is referred to as a static luminance, the average luminance of a one-field interval is referred to as a dynamic luminance, and the luminance visually recognized by a viewer is referred to as a visual luminance. In the commonly available hold-type display device, therefore, if the display data remains invariable, the static luminance, the dynamic luminance and the visual luminance are made substantially equal to one another.

According to the present invention, an interval of two or more fields (for example, a two-fields interval) is assigned to a one-frame interval to be inputted from the external system, and the display data is converted so that the visual luminance obtained from the dynamic luminance of a plural-fields interval may coincide with the display luminance expected by the external system. In this case, the visual luminance is made substantially equal to the average value of the dynamic luminance in the plural-fields interval.

The foregoing conversion of the display data is executed so that the dynamic luminance of one field may be higher than or equal to that of the other field in all the tones. In the following, as a result of this conversion, the field with a higher luminance is referred to as a light field, while the field with a lower luminance is referred to as a dark field.

In a case that two fields are assigned to a one-frame interval to be inputted by the external system, the hold-type display device according to this invention is equipped with a frame memory that stores the display data corresponding with at least one screen and two kinds of data conversion circuits. The display data written in the frame memory is divided into two, so that one data part may be read out at twice as fast a speed as the write of the display data in the frame memory. And, the display data part read at the first time is converted by the different data conversion circuit from the display data part read at the second time and the converted data is transferred as the input data to a display panel.

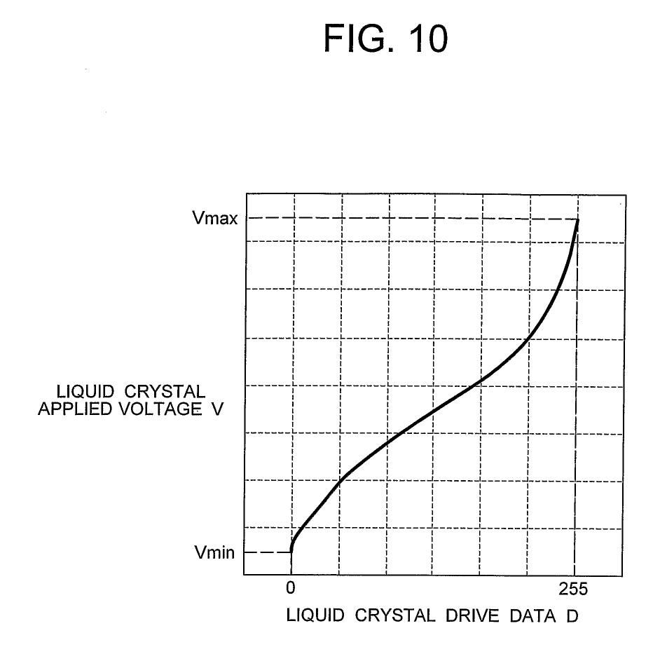

According to an embodiment of the present invention, assuming that the static luminance ranges from 0 to 1, for example, if the dynamic luminance of the light field is 0.5 and the dynamic luminance of the dark field is 0, by switching these two dynamic luminances with each other for each field, it is possible to obtain the visual luminance of 0.25. Likewise, if the dynamic luminance of the light field is 1 and the dynamic luminance of the dark field is 0, by the same exchanging operation, it is possible to obtain the visual luminance of 0.5. As such, if the dynamic luminance of the dark field is 0, the same effect as the black frame inserting system can be obtained, and thus the blurred moving image may be improved. Further, as indicated in the measured result of MPRT to be described with respect with the first embodiment, the dark field is not necessarily specified to a minimum luminance, that is, zero (0). By inserting the field with a lower luminance that the visual luminance to be displayed, the blurredness of the moving image may be reduced. Based on this fact, if the dynamic luminance of the light field is specified to 1 and the dynamic luminance of the dark field is specified to 0.5, the visual luminance is made to be 0.75. Even in this case, the blurred moving image may be improved as compared with the improvement in the normal driving system. Moreover, if the dynamic luminances of both the light field and the dark field are specified to one (1), the visual luminance is also made one, so that the luminance is not made lower. Instead, if the dynamic luminance of the light field is 1 and the maximum value of the dynamic luminance of the dark field is 0.9, the visual luminance is made 0.95. In this case, though the visual luminance is slightly lower than that in the normal driving system, the blurredness of the moving image may be reduced accordingly. In the aforementioned invention, though the improvement of the blurredness of the moving image is being reduced as the dynamic luminance of the dark field is rising, as indicated in the graph (see FIG. 10) of the Patent Publication 3 that shows the result of the experiment by testees as to the relation between the luminance of the display surface and the visibility of the moving image, it is difficult for a viewer to visually recognize the blurredness of the moving image on an area with a higher luminance. Hence, the application of this invention to the display device results in being able to obtain a far more excellent result than the values indicated in the MPRT.

Further, the multi-tone system called the FRC (Frame Rate Control) system is well known. The FRC system is a system that realizes more tones than the tones provided in the data driver by repeating the different tone display for each frame. On the other hand, the present invention provides a capability of improving the blurred moving image and a device that realizes the improvement. As means of realizing this, the present invention is different from the FRC system in that a one-frame interval is divided into the dark field and the light field and the device is driven at twice as high a frequency as the frame frequency to be inputted from the external system.

According to the first embodiment, keeping the liquid crystal driving voltage of the driving system of this invention the same as that of the normal driving system, the display device is provided which executes the data conversion so that the maximum value (white luminance) of the visual luminance is kept the same as the normal driving system, the blurred moving image is improved, and the MPRT is reduced to a minimum.

According to the second embodiment, keeping the liquid crystal driving voltage of the driving system of this invention the same as that of the normal driving system, the display device is provided which executes the data conversion so that the blurredness of the moving image is made smaller instead of slightly lowering a white luminance.

According to the third embodiment, keeping the liquid crystal driving voltage of the driving system of this invention the same as that of the normal driving system, the display device is provided which executes the data conversion so that the maximum value of the visual luminance is kept the same as the normal driving system and flickers are reduced even at a low frequency.

According to the fourth embodiment, keeping the liquid crystal driving voltage of the driving system of this invention different from that of the normal driving system, the display device is provided which executes the data conversion so that the white luminance is kept the same as that of the normal driving system and a stable characteristic is indicated to the liquid crystal display device with a relatively slow response speed.

According to the fifth embodiment, keeping the liquid crystal driving voltage of the driving system of this invention different from that of the normal driving system, the display device is provided which executes the data conversion so that the blurredness of the moving image is made smaller instead of slightly lowering the white luminance and a stable characteristic is indicated to the liquid crystal display device with a slow response.

According to the sixth embodiment, keeping the liquid crystal driving voltage of the driving system of this invention different from that of the normal driving system, the display device is provided which executes the data conversion so that the white luminance is kept the same as that of the normal driving system and a stable characteristic is indicated to the liquid crystal display device with a slow response even in the case that the display device.

According to the seventh embodiment, the display device is provided which corrects the display data by referring to the display data of a one-previous frame so that the blurredness of the moving image may be further improved.

According to the eighth embodiment, in a driving circuit system of the present invention that improves the blurred moving image as described with respect to the first to the seventh embodiments, the display device is provided which is arranged to reduce a data capacity of a frame memory and make the overall driving circuit system less costly.

According to the ninth embodiment, in the less costly driving circuit system according to the eighth embodiment, the display device is provided which is arranged to improve a characteristic of writing data to a liquid crystal display panel driven at the liquid crystal driving voltage for keeping the image quality higher.

According to the tenth embodiment, the display device is provided which controls a ratio of the light field interval and the dark field interval in the present invention for improving the blurred moving image as described with respect to the first to the ninth embodiments so that the performance of blurring the moving image may be specified to the optimal value according to the liquid crystal display panel characteristic and the request for the moving image performance.

### First Embodiment

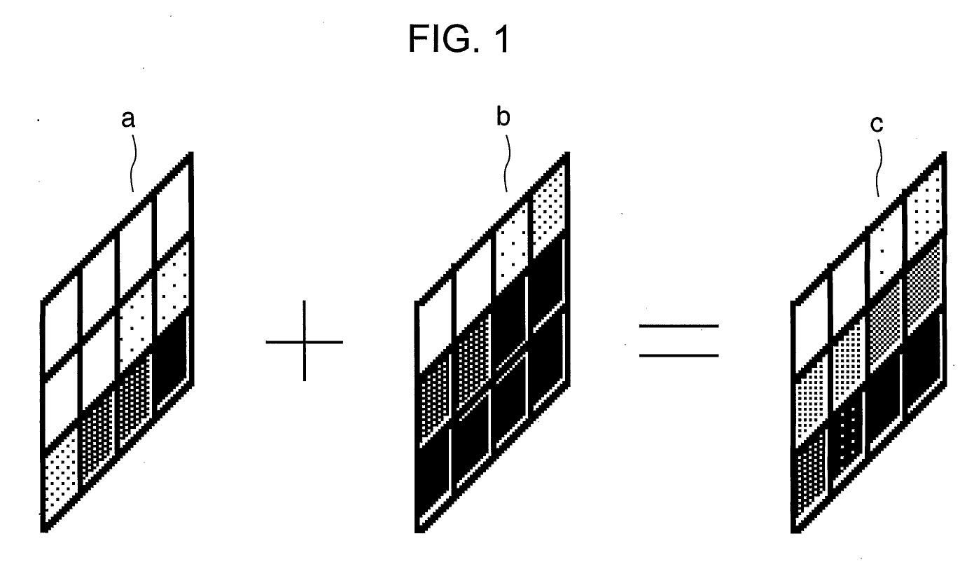

The embodiments of the present invention arranged in the case of driving one frame with two fields will be described with reference to FIGS. 1 to 12.

FIG. 1 shows the dynamic luminance and the visual luminance of each field of the display device consisting of 4×3 pixels. In FIG. 1, a denotes the dynamic luminance of the light field, b denotes the dynamic luminance of the dark field, and c denotes the visual luminance. In this embodiment, one frame is composed of two fields, and the data is displayed so that the dynamic luminance of one field is constantly lighter than or equal to the dynamic luminance of the other field with respect to any pixel. By repetitively switching these fields with each other, the target visual luminance can be obtained. Hence, with respect to any pixel, the relation of (dynamic luminance of the light field)≧(visual luminance)≧(dynamic luminance of dark field) is established. Instead of two fields for one frame, three or four fields for one frame may be specified. Also in this case, at least one of these fields is dark.

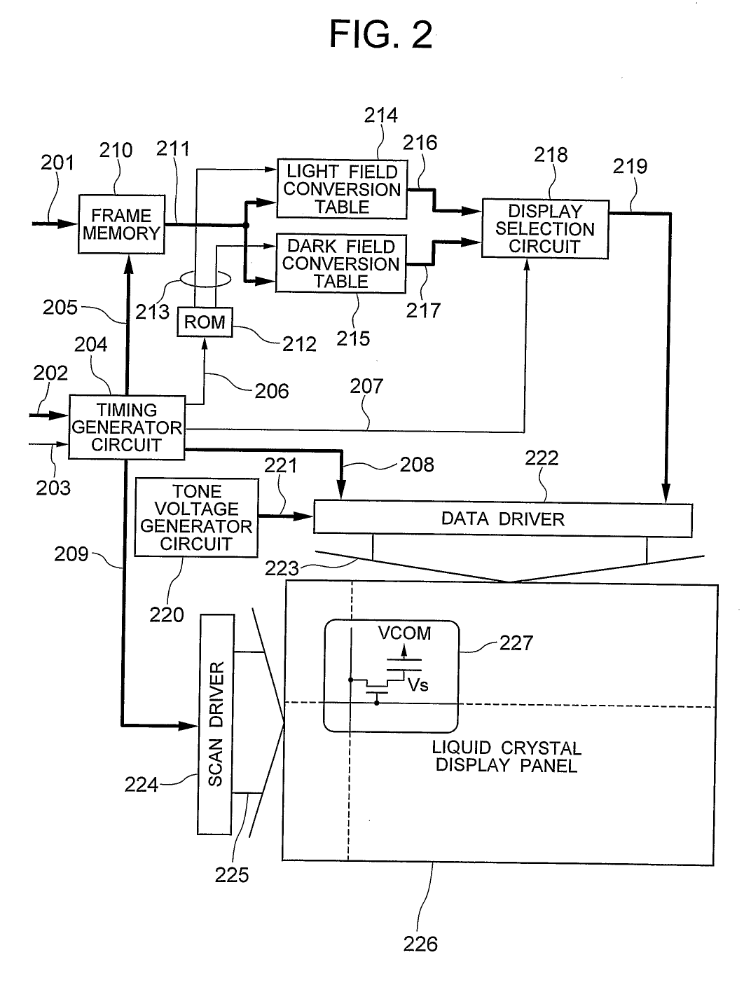

FIG. 2 shows an arrangement of the liquid crystal display device. This device offers a display of totally 16,770,000 colors and 256 tones of each RGB color. A numeral 201 denotes input display data composed of totally 24 bits, eight bits of each RGB color. A numeral 202 denotes a group of input control signals. The input control signal group 202 is made up of a vertical synchronous signal Vsync that prescribes a one-frame interval (in which data of one screen is displayed), a horizontal synchronous signal Hsync that prescribes one horizontal scan interval (in which data of one line is displayed), a display timing signal DISP that prescribes an effective interval of the display data, and a reference clock signal DCLK synchronized with the display data. A numeral 203 denotes a driving selection signal. In response to this driving selection signal 203, the LCD device selects the conventional driving system or the driving system that is arranged to improve the blurredness of the moving image. The input display data 201, the input control signal group 202 and the driving selection signal 203 are transferred from the external system (such as a TV set, a personal computer, and a cellular phone). A numeral 204 denotes a timing signal generator circuit. A numeral 205 denotes a memory control signal group. A numeral 206 denotes a table initialize signal. A numeral 207 denotes a data selection signal. A numeral 208 denotes a data driver control signal group. A numeral 209 denotes a scan driver control signal group. The data driver control signal group 208 is made up of an output timing signal CL1 that prescribes the output timing of a tone voltage based on the display data, an alternating signal M that defines a polarity of a source voltage, and a clock signal PCLK synchronized with the display data. The scan driver control signal group 209 is made up of a shift signal CL3 that prescribes a scan interval of one line and a vertical start signal FLM that prescribes a scan start of a head line. A numeral 210 denotes a frame memory having a capacity of at least one frame of display data. The frame memory 210 serves to read or write the display data based on the memory control signal group 205. A numeral 211 denotes a memory read data that is read out of the frame memory 210 based on the memory control signal group 205. A numeral 212 denotes a ROM (Read-Only Memory) 213 that outputs data stored therein. A numeral 213 denotes a table data that is outputted from the ROM. A numeral 214 denotes a light field conversion table. A numeral 215 denotes a dark field conversion table. The values of each table are set on the table data 213 when the device is powered on and the read memory read data 211 is converted on the values set on each table. The light field conversion table 214 is served as a data conversion circuit for the light field. The dark field conversion table 215 is served as a data conversion circuit for the dark field. A numeral 216 denotes light field display data converted by the light field conversion table 214. A numeral 217 denotes dark field display data converted by the dark field conversion tale 215. A numeral 218 denotes a display data selection circuit, which operates to select one of the light field display data 216 and the dark field display data 217 based on the data selection signal 207 and then output the selected data. A numeral 219 denotes the selected field display data. A numeral 220 denotes a tone voltage generator circuit. A numeral 221 denotes a tone voltage. A numeral 222 denotes a data driver. The data driver 222 operates to generate the potential of a positive polarity of 2̂8 (2⁸)=256 levels and the potential of a negative polarity of 2̂8 (2⁸)=256 levels, that is, the total potential of 512 levels from the tone voltage 221. Further, the data driver 222 operates to select a one-level potential corresponding with the polarity signal M and the field display data 219 composed of 8 bits in each color and then apply the selected data and potential as the data voltage to the liquid crystal display panel 226. A numeral 223 denotes a data voltage generated by the data driver 222. A numeral 224 denotes a scan driver. A numeral 225 denotes a scan line selection signal. The scan driver 224 operates to generate the scan line selection signal 225 based on the scan driver control signal group 209 and then output the scan line selection signal 225 to the scan line of the liquid crystal display panel. A numeral 226 denotes a liquid crystal display panel. A numeral 227 denotes a model view of one pixel included in the liquid crystal display panel 226. One pixel of the liquid crystal display panel 226 is made up of a liquid crystal layer, an opposed electrode and a TFT (Thin Film Transistor) composed of a source electrode, a gate electrode and a drain electrode. By applying the scan signal to the gate electrode, the TFT is caused to be switched. When the TFT is open, the TFT causes the data voltage to be applied in the source electrode connected with one end of the liquid crystal layer through the drain electrode, while when the TFT is closed, the TFT holds the voltage applied in the source electrode. It is assumed that the voltage of the source electrode is Vs and the voltage of the opposed electrode is VCOM. The liquid crystal layer serves to change the polarizing direction based on the potential difference between the source electrode voltage Vs and the opposed electrode voltage VCOM and change the quantity of light passed from the backlight located on the rear surface of the panel through the effect of the polarizers located on the top and the bottom of the liquid crystal layer itself. This change of the quantity of passed light makes it possible to execute the tone display.

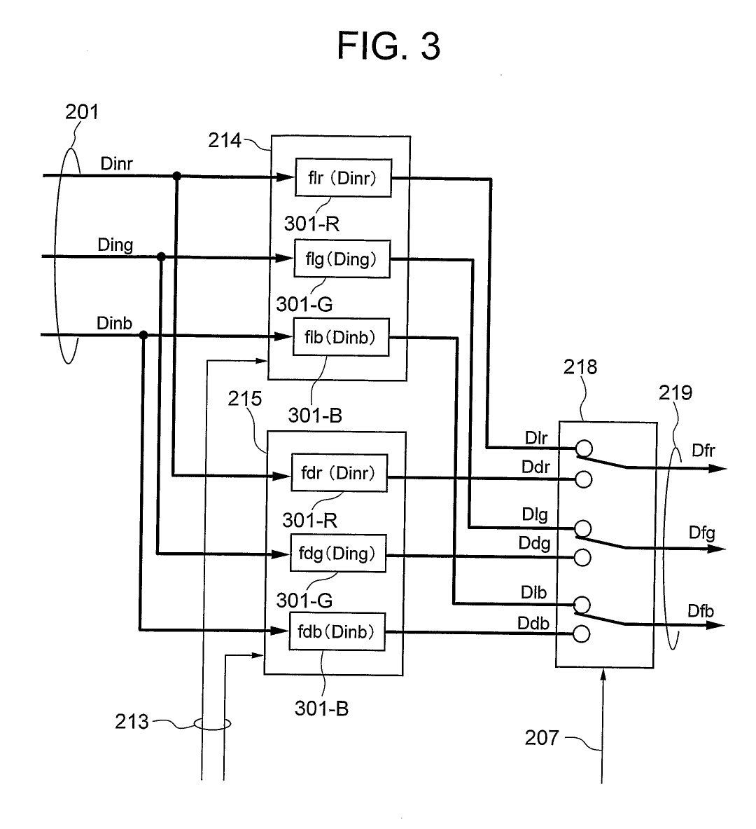

FIG. 3 shows the arrangements of the light field conversion table 214, the dark field conversion table 215 and the display data selection circuit 218. The light field conversion table 214 is composed of conversion tables 301-R, 301-G and 301-B, each table for each of the RGB colors. The dark field conversion table 215 is composed of conversion tables 302-R, 302-G and 302-B, each table for each of the RGB colors. The light field conversion table 214 converts the display data Dinr, Ding and Dinb being inputted into each conversion table into Dlr=flr(Dinr), Dlg=flg(Ding) and Dlb=flb(Dinb). The dark field conversion table 211 converts the display data Dinr, Ding and Dinb into Ddr=fdr(Dinr), Ddg=fdg(Ding) and Ddb=fdb(Dinb). Then, the display data selection circuit 218 selects any one of Dlr and Ddr converted on the R data Dinr, any one of Dlg and Ddg converted on the G data Dg, and any one of Dlb and Ddb converted on the B data Db in response to the data selection signal 207.

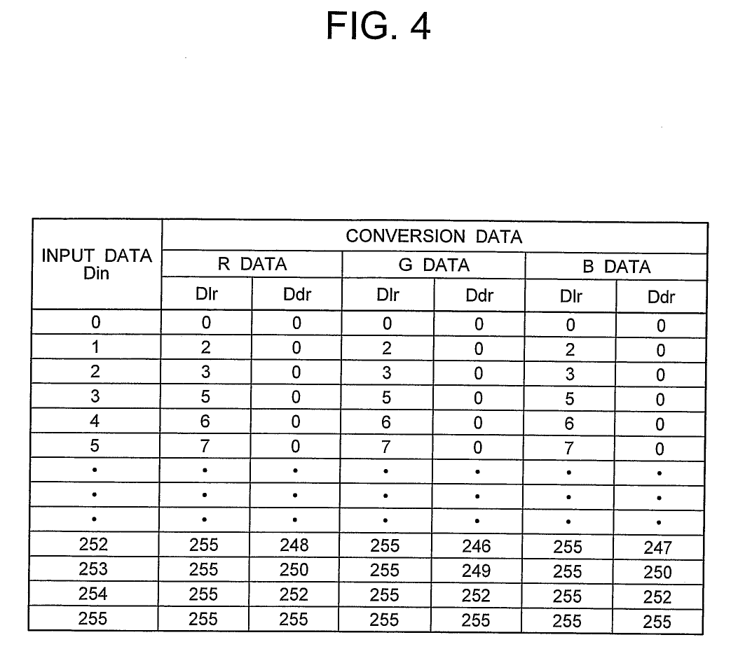

FIG. 4 shows an example of the conversion table. The input data composed of discrete values of 0 to 255 is converted into the field display data shown in the matrix with respect to the light field and the dark field.

Hereafter, the operation of the arrangement of the first embodiment will be described in detail.

In the display device according to this embodiment, the conventional driving system may be switched with the driving system of the following embodiment in response to a request given by the external system. Herein, the conventional driving system means the driving system that does not use the light field and the dark field, that is, the system that is arranged to apply to the pixels the data voltage corresponding with the display data inputted from the external system. For example, preferably, mainly for the still images as in the personal computer, the conventional driving system is applied to the display device, while mainly for the moving image as in the TV, the driving system of this embodiment is applied to the display device.

The switch of the driving system is executed on the driving selection signal 203. When an instruction of applying the driving system of this embodiment is given in response to the driving selection signal 203, the timing signal generator circuit 204 transfers the table initialize signal 206 to the ROM 212. The ROM 212 stores the table data as shown in FIG. 4 in itself. The stored data is then transferred as the table data 213 to the light field conversion table 214 and the dark field conversion table 215. On the other hand, when an instruction of applying the conventional driving system is given in response to the signal 203, no conversion is carried out. Hence, the operation is executed to set such a value as executing no conversion with respect to the memory read data 211 inputted into the light field conversion table 214 and the dark field conversion table 215. This value may be stored in the ROM 212 or set as an initial value in the conversion table 215 and 216. In the conventional driving system, one frame may be driven in two fields, (which means that the same data is written twice in one frame to each pixel), or in one field, (which means that the same data is written once in one frame to each pixel). In the following, the description will be oriented to the case that the driving system composed of the light field and the dark field is selected for the purpose of improving the blurred moving image.

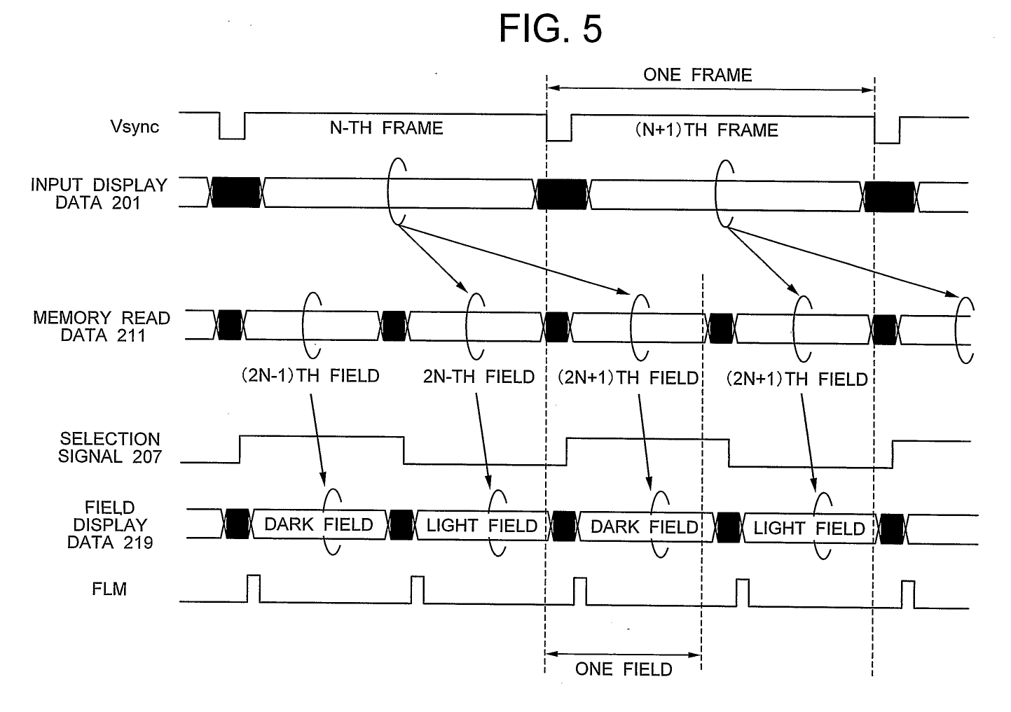

FIG. 5 shows a timing specification in the case of applying the present invention to the display device.

Based on the control signal group 202 inputted from the external system, the timing signal generator circuit 204 generates the memory control signal group 205, the data selection signal 207, the data driver control signal group 2078, and the scan driver control signal group 209. After the display data 201 is temporarily written in the frame memory 210 based on the memory control signal group 205, as shown in the timing chart of FIG. 5, the data of the N-th (N is an integer of 0 or more) frame is read as the memory read data 211 twice, that is, the 2N-th (even field) field and the (2N+1)th (odd field) field. Since the display data of one frame is read twice, the interval required for reading the display data of one line becomes substantially half as long as that of the horizontal synchronous signal Hsync. This may be easily realized by reading the data from the frame memory at a doubled speed or making the bus width doubled and generating a signal with a 2-multiplied period of a vertical synchronous signal Vsync or a horizontal synchronous signal Hsync.

The memory read data 211, read by the foregoing operation, is transferred to the light field conversion table 214 and the dark field conversion table 215, in which the corresponding conversion with the display data is carried out. This conversion may be changed according to each of the RGB colors as shown in FIG. 3. This conversion depends upon the characteristics of the liquid crystal display device such as a wavelength dispersed characteristic of the liquid crystal display element. Conversely, for a certain characteristic of the liquid crystal display device, only one conversion table may be selected for each color. In this case, the size of the conversion table may be reduced into ⅓.

To describe the conversion table more particularly, the conversion table is composed in matrix as shown in FIG. 4. For example, if the R (Red) data Dinr of the memory read data 211 is equal to 4, the light field conversion table 301-R for red converts the Dinr=4 into Dlr=6 and the dark field conversion table 302-R for red converts the Dinr=4 into Ddr=0. Likewise, if the G (Green) data Ding of the memory read data 211 is equal to 253, the light field conversion table 301-G for green converts Ding=253 into Dlg=255 and the dark field conversion table 302-G for green converts Ding=253 into Ddg=249. These conversions may be realized in at most several clocks. As described above, in the display data selection circuit 218, any one of the light field display data 216 and the dark field display data 217 converted through the tables is selected as the field display data 219 in response to the data selection signal 207. As shown in FIG. 5, the data selection signal 207 changes its polarity depending upon if the memory read data 211 is the first read data or the second read data. Hence, the data selection signal 207 of this embodiment is synchronized with the vertical synchronous signal Vsync, so that the high interval is made substantially equal to the low interval in the same frequency as the vertical synchronous signal Vsync.

As set forth above, the converted and selected field display data 219 is transferred to the data driver 222 together with the data driver control signal group 208. The data driver 222 selects the voltage of one level corresponding with the field display data 219 and the polarity signal M of 256 tone voltages of a positive polarity or a negative one, those 256 tone voltages being generated by dividing the tone voltage 221 based on the field display data 219 and then outputs the selected voltage to the liquid crystal display panel 226 based on the output timing signal CL1 included in the data driver control signal group 208. At a time, based on the scan driver control signal group 209, the scan driver 224 selects the scan line of the liquid crystal display panel 226 and applies the potential of the drain electrode as the source voltage Vs in the source electrode through the TFT with respect to each pixel of the selected scan line. This causes the potential difference between the opposed electrode voltage VCOM and the source voltage Vs to be applied to the liquid crystal layer.

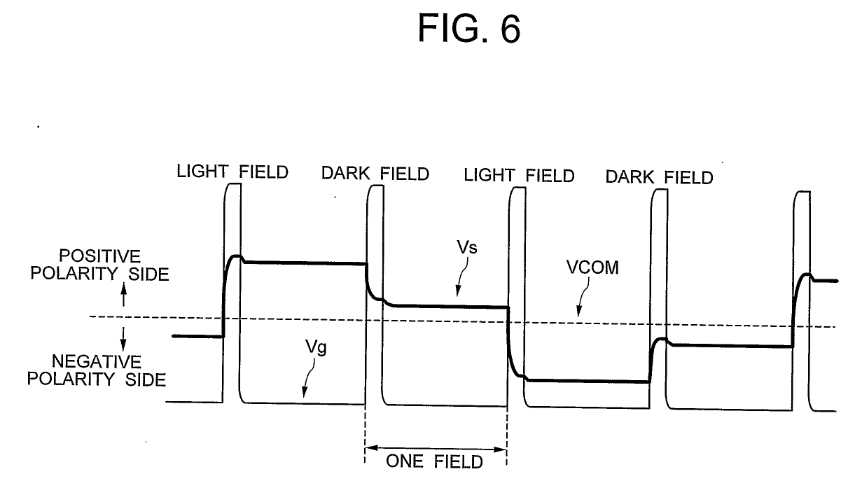

FIG. 6 shows a waveform of a driving voltage to be applied to one of the pixels composing the liquid crystal display panel.

If the DC components of the driving voltage are applied to the liquid crystal display element for a relatively long interval (several tens to several hundreds seconds or longer), a burn-in occurs for a short length of time. Further, if the DC components of the driving voltage are applied thereto for a longer interval (several tens and several hundreds days or longer), the element break, in which the element is not returned to the original state, may be brought about. In order to prevent these shortcomings, the liquid crystal display device adopts the polarity inversion driving system called a dot inversion system or a line inversion system. Herein, the polarity means the potential level of the source voltage VS viewed from the opposed electrode voltage VCOM. Hereafter, if the source voltage Vₛ is higher than the opposed electrode voltage VCOM, it is called a positive polarity, while if it is lower, it is called a negative polarity. In these driving systems, the polarity of one pixel is different from that of the adjacent pixel. In actual, the polarity of each pixel is changed in each write.

On the other hand, in the case of applying the present invention to the liquid crystal display device for executing the halftone display, if the light field conversion table is different in values from the dark field conversion table, the absolute value of the source voltage of the light field is different from that of the dark field and the light field and the dark field are alternately displayed. In the conventional AC period, therefore, the DC components are applied into the liquid crystal display element.

In order to prevent this shortcoming, in this embodiment, the AC period is changed every two fields as shown in FIG. 6. That is, if the polarity of the applied voltage in a light field is positive, the polarity of the adjacent light field is negative, and the polarity of the next adjacent light field is positive. Likewise, with respect to the dark field, the positive and the negative polarities of the voltage applied onto the liquid crystal display element are alternately switched with each other. However, no condition on the polarity is given in the adjacent light and dark fields. Hereafter, the driving system in which the polarity is reversed every two fields is called a two-fields inversion system. Likewise, the driving system in which the polarity is reversed every n-fields is called an n-fields inversion system. Moreover, in this embodiment, one frame interval is divided into two field intervals. “Every two fields” means “every frame”.

In a case that the input display data is kept constant, the application of the foregoing two-fields inversion system makes it possible to cancel the DC components of the light field and the dark field.

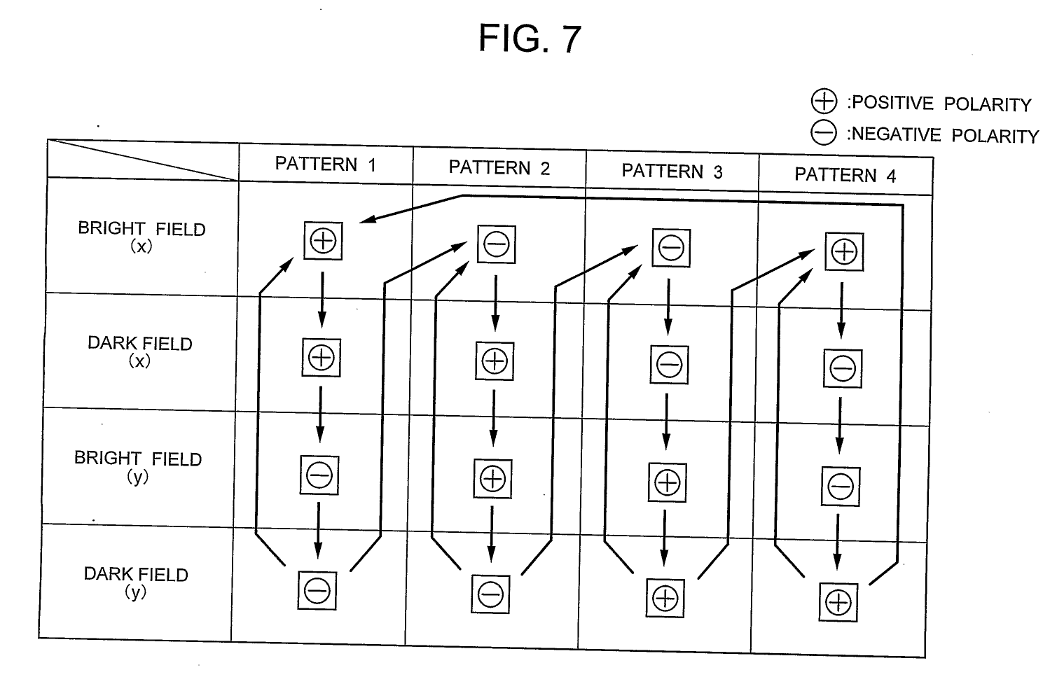

FIG. 7 shows an example of an AC period to be applied to one pixel. In FIG. 7, the polarity is reversed every two fields or every three fields if necessary.

For some broadcast image signals, the polarity may constantly changed at a display pattern and at a period of two to four frames. The method of canceling the DC components caused by this change will be described with reference to FIG. 7.

FIG. 7 shows the change of the polarity of a certain particular pixel. (x) and (y) denote the input display data. The display pattern is changed every two frames. As is viewed in FIG. 7, in the pattern 1, the polarity is sequentially changed in the process of the light field: positive polarity (x) to the dark field: positive polarity (x) to the light field: negative polarity (y) to the dark field: negative polarity (y).

In the pattern 2, the polarity is sequentially changed in the process of the light field: negative polarity (x) to the dark field: positive polarity (x) to the light field: positive polarity (y) to the dark field: negative polarity (y). In the pattern 3, the polarity is sequentially changed in the process of the light field: negative polarity (x) to the dark field: negative polarity (x) to the light field: positive polarity(y) to the dark field: positive polarity (y).

In the pattern 4, the polarity is sequentially changed in the process of the light field: positive polarity (x) to the dark field: negative polarity (x) to the light field: negative polarity (y) to the dark field: positive polarity (y). In a case that the display data is stationary, that is, x=y, in any pattern, the two-fields inversion system is used, so that no DC components are applied onto the liquid crystal element.

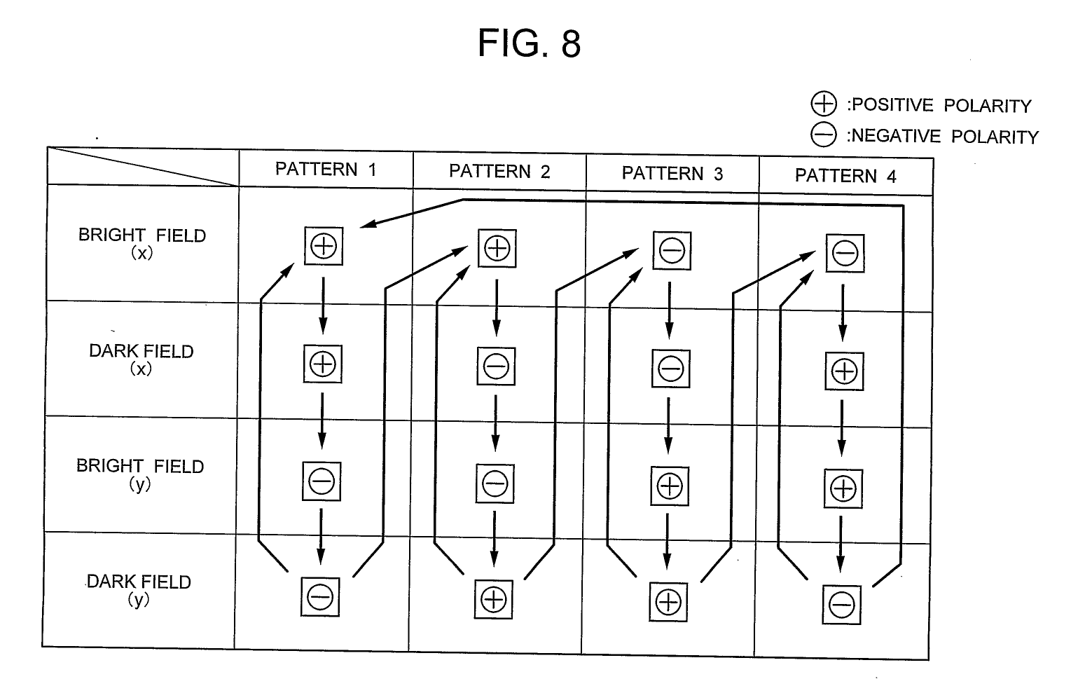

On the other hand, in a case that the current is alternated only in each pattern in the condition of x≠y, in any pattern, the absolute value of the voltage applied to the liquid crystal of the positive polarity is different from the absolute value of the voltage of the negative polarity, so that the DC components are applied to the liquid crystal. However, by changing the AC pattern as indicated by an arrow, that is, from the pattern 1 to the pattern 2 and from the pattern 2 to the pattern 3 and combining four patterns at the same ratio, the ratio of the positive polarity to the negative one is made equal in any field. As a result, no DC components are applied. The minimum frames required for combining these four patterns correspond to the frames that do not pass through the arrow shifted from the dark field (y) to the light field (x) in each pattern. In actual, eight frames, that is, 16 fields are required. Herein, in a case that one frame is 60 Hz based on the NTSC signal, the interval required for eight frames is about as short as 133 ms. This is far shorter than several tens seconds for which the short burn-in takes place. Conversely, in a case that the short burn-in takes place for a length of 40 seconds, by repeating the pattern 1 for 20 seconds, shifting to the pattern 2 and repeating the pattern 2 for 20 seconds, shifting to the pattern 3 and repeating the pattern 3 for 20 seconds, shifting to the pattern 4 and repeating the pattern 4 for 20 seconds, and shifting to the pattern 1 and repeating the pattern 1 for 20 seconds, the continuous application of the AC components takes 40 seconds at maximum. Hence, this operation makes it possible to prevent the short burn-in. Further, in a case that the AC period is changed on the way of the halftone display in the normal driving system, the luminance is slightly changed before and after the change, and the luminance change may be observed as flickers with human's eyes. On the other hand, in the halftone display of the driving system of this embodiment, since the applied voltage of the light field is different from that of the dark field and the liquid crystal display element is constantly in response, the flickers may be sufficiently suppressed. FIG. 8 shows an example of an AC period to be applied to another pixel rather than that of FIG. 7. In FIG. 8, the polarity is reversed every two fields or every one field if necessary. As shown in FIG. 8, in the case of combining the two-fields inverting system and the one-field inverting system, like the case of FIG. 7, the necessary length for canceling the DC components resulting from the display data at a two-frames unit is at least eight frames composed of 16 fields.

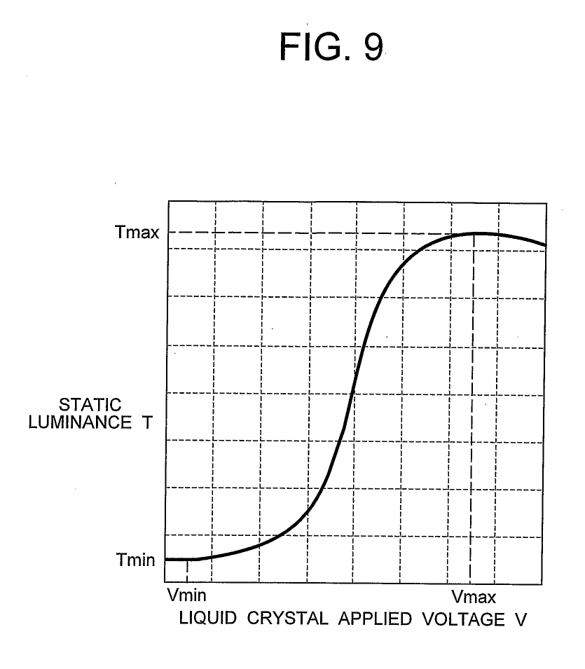

Hereafter, the description has been oriented to the flow of the operation of this embodiment. Next, the conversion algorithm of the light field conversion table 214 and the dark field conversion table 215 will be described in detail with reference to FIGS. 9 to 13. In FIG. 3, the conversion table is prepared for each of the RGB colors. However, as mentioned earlier, by properly setting the characteristics of the color filters and the backlight, the same conversion table may be used for each color. For facilitating the description, in the following description, the conversion table uses the common values for each color.

FIG. 9 is a graph showing a V-T characteristic, in which graph an axis of abscissas denotes a voltage V applied onto the liquid crystal (often referred to as a liquid crystal applied voltage V), which corresponds to an absolute value of an electric potential between the source electrode voltage Vs and the opposed electrode voltage VCOM, and an axis of ordinance denotes a static luminance T of the liquid crystal display panel.

In the liquid crystal display panel, generally, the liquid crystal applied voltage V is changed with respect to the static luminance T as indicated in the V-T characteristic, and the static luminance includes a Tmin point at which the luminance becomes minimum and a Tmax at which the luminance becomes maximum. For the 256-tones display in normally black, therefore, the liquid crystal applied voltage Vmin at which Tmin occurs is made to correspond with the 0 tone of the liquid crystal drive data D and the liquid crystal applied voltage Vmax at which Tmax occurs is made to correspond with the 255 tones of the liquid crystal drive data D. In actual, since the liquid crystal display is required to consider its variety, Tmin and Tmax are not necessarily specified to the 0 tone and the 255 tons. Tmin includes a range of 5% or some before and after the minimum static luminance and Tmax includes a range of 5% or some before and after the maximum static luminance. For the 256-tones display in normally white, the relation between the luminance and the liquid crystal applied voltage is reverse to the relation of the 256-tones display in normally black.

The display is requested to make the luminance difference between each adjacent tones closer to an equal interval. For 256 tones, in general, the relation between the liquid crystal drive data D and the static luminance T is as follows:

(Static Luminance T)=(Liquid Crystal drive Data D/255)̂γ (expression 1)

That is, the display is designed to meet the so-called gamma curve. In addition, γ=2.2 is commonly used as a value of γ. Hence, the description will be expanded as γ=2.2.

In the liquid crystal display panel having the static luminance characteristic shown in FIG. 9 and the gamma characteristic indicated by (expression 1), the relation between the liquid crystal drive data D and the liquid crystal applied voltage V is uniquely defined.

FIG. 10 is a graph showing a D-V characteristic, in which graph an axis of abscissa denotes the display data to be inputted into the data driver 222 and an axis of ordinance denotes an absolute value of a data voltage to be outputted from the data driver 222. As shown in FIG. 10, on the low tone and high tone side, the D-V characteristic indicates that the gradient of the D-V characteristic becomes acute and the change of the liquid crystal drive data D is made greater than the change of the liquid crystal applied voltage V.

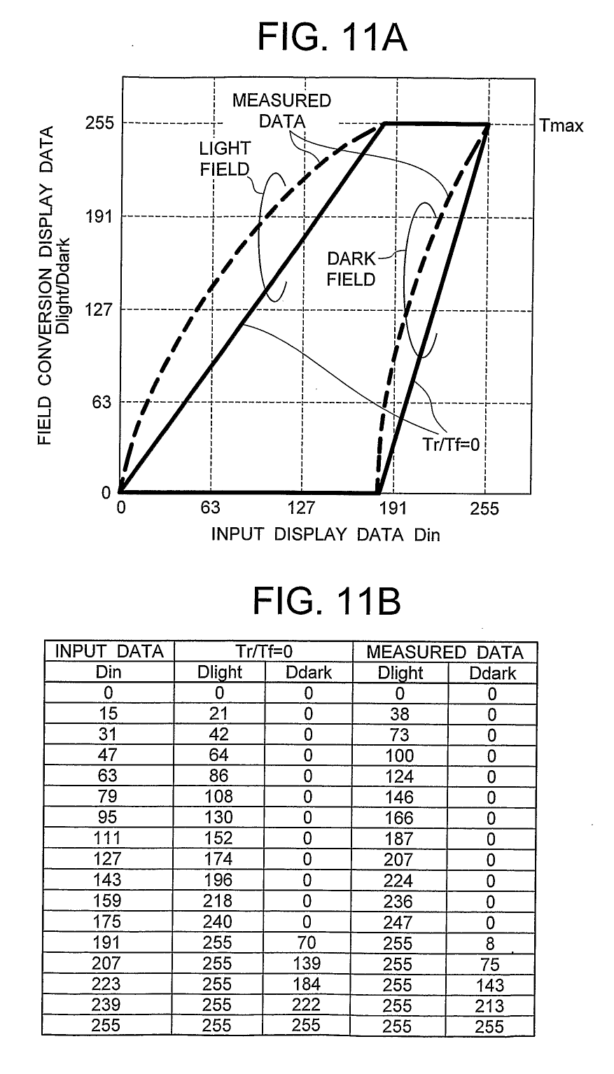

FIG. 11A is a graph showing a characteristic of conversion from the input display data into the field display data, in which graph an axis of abscissa denotes the input display data and an axis of ordinance denotes the light field display data and the dark field display data. FIG. 11B shows a more concrete conversion characteristic than FIG. 11A.

In this embodiment, the conversion algorithm realizes the corresponding visual luminance with the input display data in combination of the light field and the dark field. The dark field is conditioned to obtain the dynamic luminance that is as close to Tmin as possible and make the static luminance of the 255 tones at which the input display data becomes the lightest be equal to Tmax. (Hereafter, this condition is referred to as the condition 1.) As the dynamic luminance of the dark field is made smaller and as the range in which the dynamic luminance of the dark field is small is made larger, the blurredness of the moving image may be reduced. Hence, though it is preferable to keep the dark field at Tmin, a little higher luminance than Tmin is allowed. The range in which the dynamic luminance of the dark field is Tmin covers from the 0 tone to the tone(s) of the input display data corresponding with the visual luminance obtained with the dynamic luminance of the light field as Tmax and the dynamic luminance of the dark field as Tmin. However, a little smaller tone than the tone of the corresponding input display data is allowed. Further, the range in which the dynamic luminance of the light field keeps Tmax covers from the tone of the input display data corresponding with the visual luminance obtained with the dynamic luminance of the light field as Tmax and the dynamic luminance of the dark field as Tmin to the 256 tones. However, a little smaller tone than the tone of that corresponding input display data is allowed.

Assuming that both the rise time Tr and the fall time Tf of the liquid crystal display element are zero, the display luminance may be approximated as follows.

$$( display luminance ) = ( static luminance T of light field ) / 2 + ( static luminance T of dark field ) / 2 \qquad ( expression 2 )$$

Assuming that the input display data is Din, the light field display data is Dlight and the dark field display data is Dark, in the case of γ=2.2, from the expression 1 and the expression 2, the following expression is derived.

$$Dlight = \{ \begin{matrix}2 \hat{} ( 1 / 2.2 ) ⋆ Din & wherein 2 \hat{} ( 1 / 2.2 ) ⋆ Din < 255 \\ 255 & wherein 2 \hat{} ( 1 / 2.2 ) ⋆ Din ≧ 255\end{matrix} \\ Ddark = \{ \begin{matrix}0 & \begin{matrix}wherein 2 \hat{} ( 1 / 2.2 ) ⋆ \\ Din < 255\end{matrix} \\ 255 ⋆ \{ \begin{matrix}2 ⋆ ( Din / 255 ) \hat{} \\ 2.2 - 1\end{matrix} \} \hat{} ( 1 / 2.2 ) & \begin{matrix}wherein 2 \hat{} ( 1 / 2.2 ) ⋆ \\ Din ≧ 255\end{matrix}\end{matrix} \qquad ( expression 3 )$$

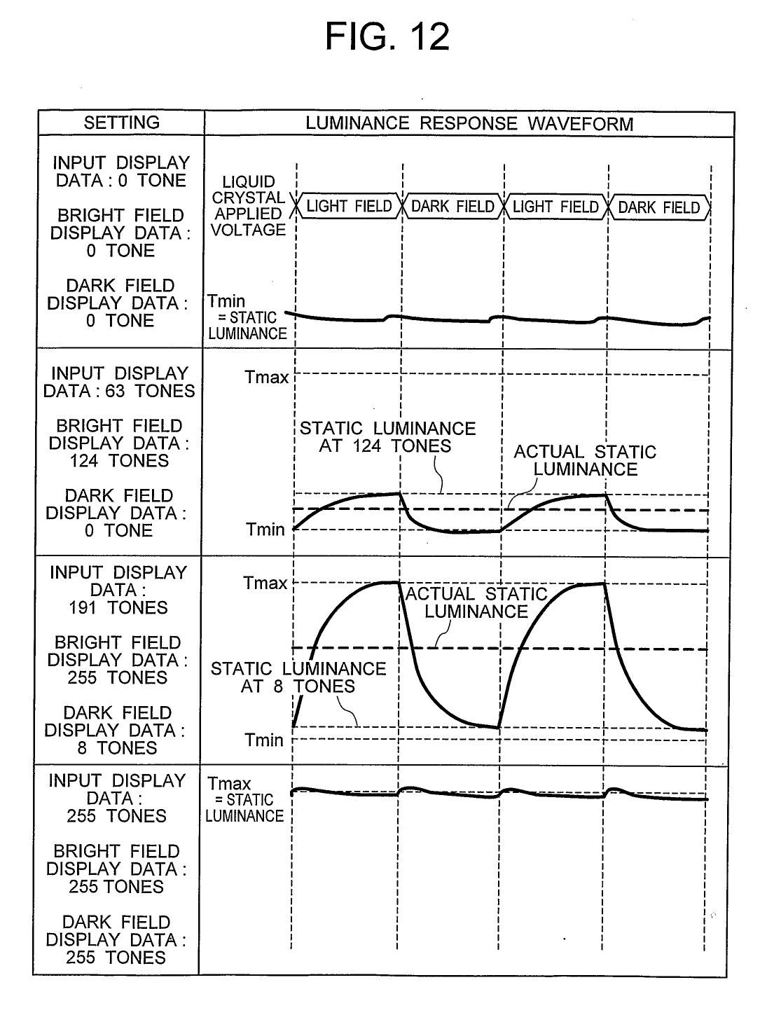

As a result, the characteristic indicated by the real line of FIG. 11A can be obtained. In FIG. 11A, the difference between the tone of the light field and the tone of the dark field is at most 255 tones. The theoretical value is about 240 tones and the measured value is about 247 tones. On the other hand, as a result of obtaining the measured data from the 32 type IPS system liquid crystal display panel with a 256-tones data driver to which the conversion algorithm indicated in the condition 1 is applied, as indicated in real line, an upward convex characteristic appears in the areas in which the conversion data in the light field stays out of the 255 tones and in which the conversion data in the dark field stays out of the 0 tone. As such, the relation between the input display data and the conversion display data is variable depending upon the response characteristic of the liquid crystal display element to which the conversion algorithm is applied even on the basis of the condition 1. Further, the conversion table is not inevitably required to have a table width over the all the input display data. If the linearity between the tones is sufficiently met, as shown in FIG. 11B, for example, a table of every 16 tones is prepared and the conversion display data may be generated by the interpolation such as the linear interpolation with respect to the tones therebetween. This makes it possible to reduce the conversion table in size. The luminance response waveform of the liquid crystal panel in the case of using the conversion table is shown in FIG. 12. As understood from FIG. 11B, the difference of the tone between the light field and the dark field is theoretically about 240 tones at most, and the measured value is about 247 tones. The light field display data Dlight does not constantly take a simply doubled value of the input display data Din.

FIG. 12 shows the luminance response waveforms over plural fields for the black display (input display data: 0 tone), the lower tone (input display data: 63 tones), the higher tone (input display data: 191 tones), and the white display (input display data: 255 tones). FIG. 12 shows the case in which the input display data consists of 0 tone and the static luminance is Tmin, the case in which the input display data consists of 63 tones and indicates the lower luminance halftone display, the case in which the input display data consists of 191 tones and indicates the higher luminance halftone display, and the case in which the input display data consists of 255 tones and the maximum luminance is Tmax. In the case of using the measured data of FIG. 11B as the conversion table, if the input display data consists of 0 tone, the field display data in the light and the dark fields consist of 0 tone. Hence, the field display data becomes the minimum luminance Tmin irrespective of the light or dark field. In a case that the input display data consists of 63 tones, the display data of the light field is converted into the data of 124 tones and the display data of the dark field is converted into the data of 0 tone, based on these conversions, the luminance is changed for each field. However, the resulting visual luminance is equal to the luminance provided in the case that the input display data consists of 63 tones. In a case that the input display data consists of 191 tones, the display data of the light field is converted into the display data of 255 tones and the display data of the dark field is converted into the display data of 8 tones, based on these conversions, the luminance is changed for each field. However, the resulting visual luminance is equal to the luminance provided in the case that the input display data consists of 191 tones. In a case that the input display data consists of 255 tones, the display data of the light field and the dark field are converted into the display data of 255 tones. Hence, the resulting static luminance becomes the maximum value Tmax.

For the measured data, the input display data, in which the light field display data consists of 255 tones and the dark field display data consists of 0 tone, specifies the 188 tones. Hence, in the lower tone than the 188 tone, the 188 tones are selected from the 256 tones as the light field display data, while in the higher tone than the 189 tones, the 66 tones are selected from the 256 tones as the dark field data. It means that the number of tones is not short. The first interval of one frame may be specified as the light field interval and the second interval thereof may be specified as the dark field interval. Conversely, the first interval of one frame may be specified as the dark field and the second interval of one frame may be specified as the light field.

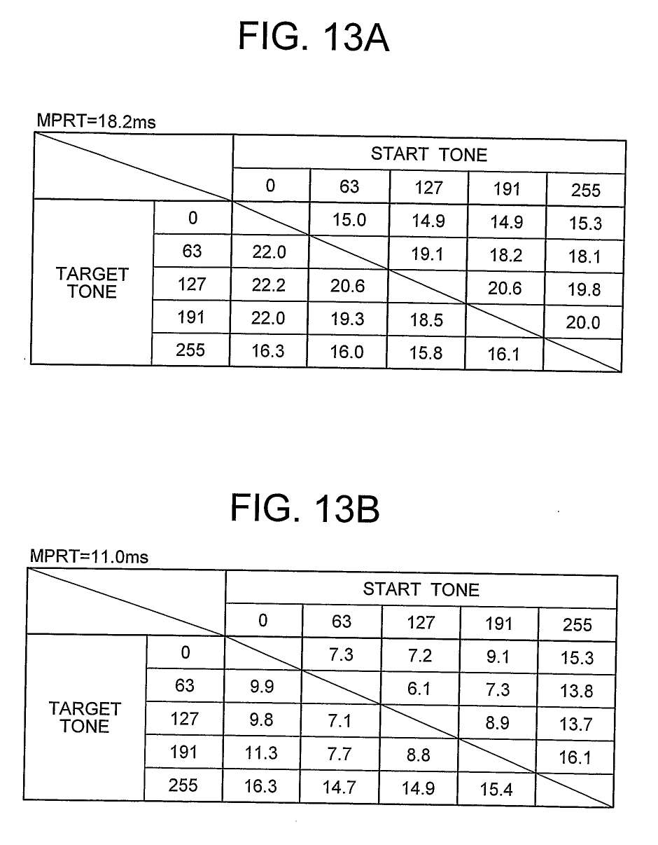

The present embodiment is realized by the foregoing arrangement and conversion algorithm. The effect thereof is indicated as the measured results of N-BET and MPRT as shown in FIG. 13. Herein, the N-BET (Normalized Blurred Edge Time) is a numerical value by normalizing the blurred edge of the moving image with the moving speed. The MPRT (Moving Picture Response Time) is an average value of N-BET between the tones. The unit is ms and as the value is made smaller, the blurred moving image is improved.

FIG. 13 shows the measured values of N-BET and MPRT that are the indexes of the blurredness of the moving image with respect to the conventional driving system and this embodiment. FIG. 13A shows the measured values in the case of applying the normal driving system with a field frequency of 60 Hz into the input display data with a frame frequency of 60 Hz through the effect of the foregoing 32-type IPS system liquid crystal display panel. FIG. 13B shows the measured values in the case of applying the driving system of this embodiment into the input display data with a frame frequency of 60 Hz and driving the device in the light and the dark fields with the field frequency of 120 Hz. Herein, the normal driving system means the system of not applying the existing technology of improving the blurred moving image such as the so-called overdrive driving system or the blink backlight system in which the waveform is shorted based on the input display data, for example by comparing the display data of the previous frame with that of the current frame. The driving system of this embodiment also does not apply any existing technology of improving the blurred moving image. As the estimated result, the MPRT value is greatly reduced from 18.2 ms of FIG. 13A into 11.0 ms of FIG. 13B. In particular, on the halftone lower luminance side, a high improvement is indicated.

### Second Embodiment

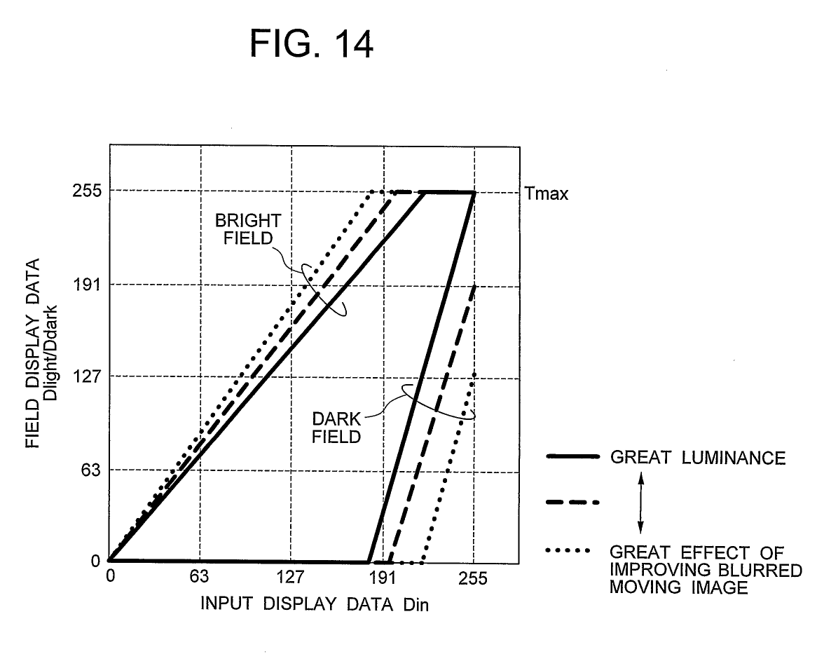

In turn, the description will be oriented to the different conversion algorithm of the display data about the light field and the dark field from that of the first embodiment through the use of the relation among the input display data 201, the light field display data 216 and the dark field display data 217 shown in FIG. 14.

In the field conversion described in the first embodiment, the conversion is carried out on the condition 1. On the other hand, the second embodiment is conditioned to realize the visual luminance corresponding with the input display data in the combination of the light and the dark fields, obtain the dynamic luminance that becomes as close to Tmin as possible as the dark field, and improve the moving image performance in the case of changing the tone into the white luminance (255 tones). This condition is referred to as the condition 2. To realize the condition 2, in this embodiment, the maximum value of the static luminance in the dark field is Tmax or less as shown in FIG. 14. Herein, as shown in FIG. 13, the N-BET is reduced in the case that the dark field data does not consist of 0 tone. Hence, for the display data of 255 tones, by changing the static luminance of the light field and the dark field, the moving image may be improved accordingly though the visual luminance is made lower. In this case, for improving the blurred moving image, as shown in FIG. 14, as the input display data is lowering the dark field display data for 255 tones, the overall luminance characteristic is required to be reduced according to the gamma characteristic indicated in the expression 1. On the other hand, the static luminance is not changed in the case that the light field display data consists of 255 tones (though the dynamic luminance is made lower because it responds to the dark field previous to this light field). Hence, as the maximum value of the dark field display data is made lower, the minimum value of the input display data with the light field display data of 255 tones is made smaller.

By carrying out the conversion based on the foregoing algorithm, as compared with the first embodiment, though the white luminance is made lower, the blurredness of the moving image may be improved for the higher luminance side accordingly.

### Third Embodiment

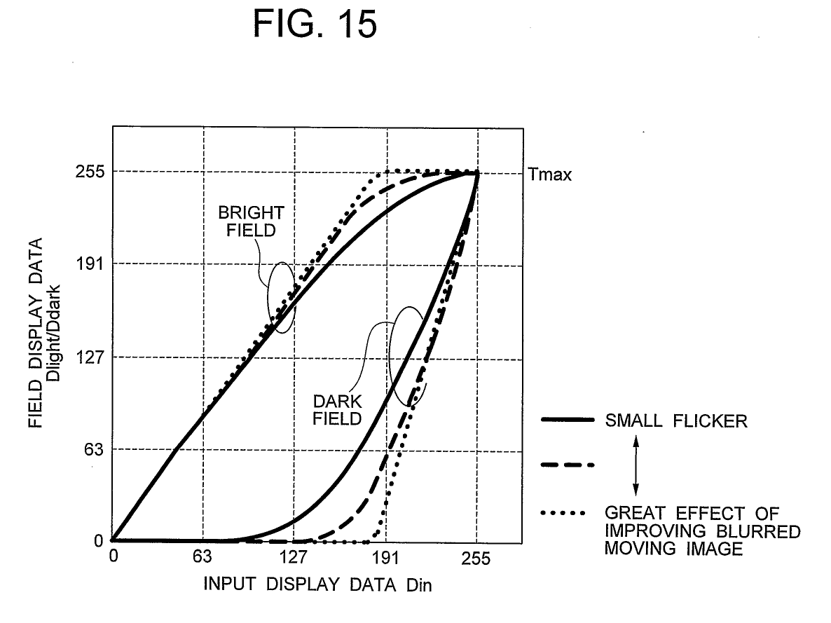

In turn, the description will be oriented to the different conversion pattern from those of the first and the second embodiments through the use of the relation among the input display data 201, the light field display data 216 and the dark field display data 217 shown in FIG. 15.

In the meantime, as the typical frame frequencies of the broadcast wave are known the NTSC system, the PAL system and the SECAM system. In the NTSC system, the scan frequency of one screen (which is a field frequency of the so-called interlaced scan system, though it is different from the field frequency used in this specification) is about 60 Hz. When driven in two fields, the frequency of one field is about 120 Hz. On the other hand, the scan frequency of one screen in the PAL system or the SECOM system is about 50 Hz. When driven in two fields, the frequency of one field is about 100 Hz. As the dynamic luminance in the dark field is being lowered by using the conversion algorithm of the first or the second embodiment, the blurredness of the moving image is reduced more as the afterimage on the retina is reset. When the field frequency is lower than about 110 Hz, the flickers are started to be visually recognized. On the other hand, as shown in FIG. 15, before the light field display data reaches the 255 tones, the dark field display data is changed from the 0 tone. That is, the dark field display data is being gradually changed from the 0 tone. This makes it possible to reduce the difference of the dynamic luminance between the light field and the dark field as keeping the visual luminance. The difference of the tones between the light field and the dark field is about 140 tones at maximum. Hence, the flickers may be reduced in the case of lowering the input frequency supplied from the external system though the improving effect of the blurredness of the moving image is slightly degraded as compared with the first embodiment.

Further, in the case of applying the conversion algorithm of the condition 1 indicated in the first embodiment to the data driver for 256 tones, the number of obtained tones is totally 509, in which the dark field is specified as the 0 tone, the light field consists of 255 tones ranging from the one tone to the 255 tones, the light field is specified as the 255 tones, and the dark field consists of 254 tones ranging from the one tone to the 254 tones. From those obtained tones are excluded the 0 tone and the 255 tones in the input display data and are selected 254 tones. On the other hand, in the condition 3, the 256 tones including the white display and the black display are merely required to be selected from the totally 99000 tones, the light field consists of 256 tones ranging from 0 to 255 tones when the dark field is specified as 0 tone, the light field consists of 255 tones ranging from one to 255 tones when the dark field is specified as one tone, the light field consists of 254 tones ranging from the two tones to the 255 tones when the dark field is specified as two tones, . . . the light field consists of 254 and 255 tones when the dark field is specified as the 254 tones, and the light field consists of only one tone when the dark field is specified as the 255 tones. Therefore, the third embodiment makes it possible to realize the tone display with more excellent gamma characteristic according to the massive number of tones.

### Fourth Embodiment

In turn, the description will be oriented to the different arrangement from that shown in FIG. 2 with reference to FIG. 9 and FIGS. 16 to 18.

In comparison with the first and the second embodiments, the fourth embodiment provides the display device which is arranged to improve the rising time of the liquid crystal display element by changing the tone voltage in the normal driving system and the driving system of the present embodiment, reduce the luminance of the dark field on the halftone higher tone side by the improvement, and make the blurred moving image better according to the reduction of the luminance.

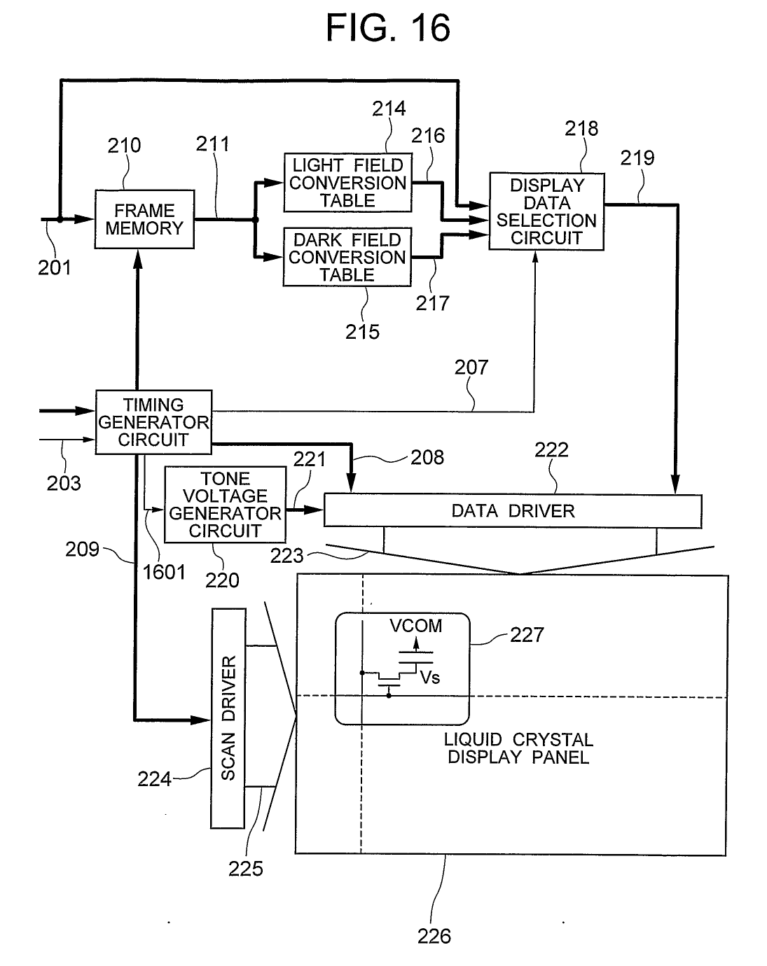

FIG. 16 shows an arrangement of this embodiment, in which figure the same functional components as those of FIG. 2 have the same reference numbers. A numeral 1601 denotes a tone voltage control signal. In this embodiment, by changing the tone voltage in the normal driving system and the driving system of the present invention driven in two fields consisting of the light field and the dark field in response to the tone voltage control signal, with respect to the liquid crystal display panel with a relatively slow response speed, the performance of the moving image can be improved more widely. In addition, though the ROM 212 shown in FIG. 2, the table initialize signal 206 annexed therewith, and the table data 213 are not illustrated in FIG. 16, the non-illustration does not restrict the embodiment. Further, the display data selection circuit 218 shown in FIG. 2 is arranged to select one of two inputs, while the circuit 218 shown in FIG. 16 is arranged to select one of three data including the input display data 201. That is, the input display data 201 is directly inputted into the display data selection circuit 218 without passing through the frame memory 210, the light field conversion table 214, and the dark field conversion table 215. In a case that the input display data 201 is selected as the output data sent from the display data selection circuit 218, the fourth embodiment selects the so-called normal driving system that drives one frame in one field.

In a case that the normal driving system is selected on the basis of the driving selection signal 203, the data voltage directly corresponding with the input display data is transferred to the liquid crystal display panel 226. Then, based on the input control signal group 202, the timing generator circuit 204 generates the data driver control signal group 208 and the scan driver control signal group 209 being suitable to the display panel. In this case, if the vertical synchronous signal Vsync of the control signal group 202 is 60 Hz, the vertical start signal FLM to be transferred to the liquid crystal display panel becomes about 60 Hz. The tone voltage generator circuit 220 outputs a tone voltage that is curved as a gamma characteristic according to the normal driving system and executes the display based on the tone voltage.

Likewise, in the case of selecting the driving system that improves the blurred moving image, the tone voltage generator circuit 220 outputs the data voltage being suitable to this embodiment based on the tone voltage control signal 1501.

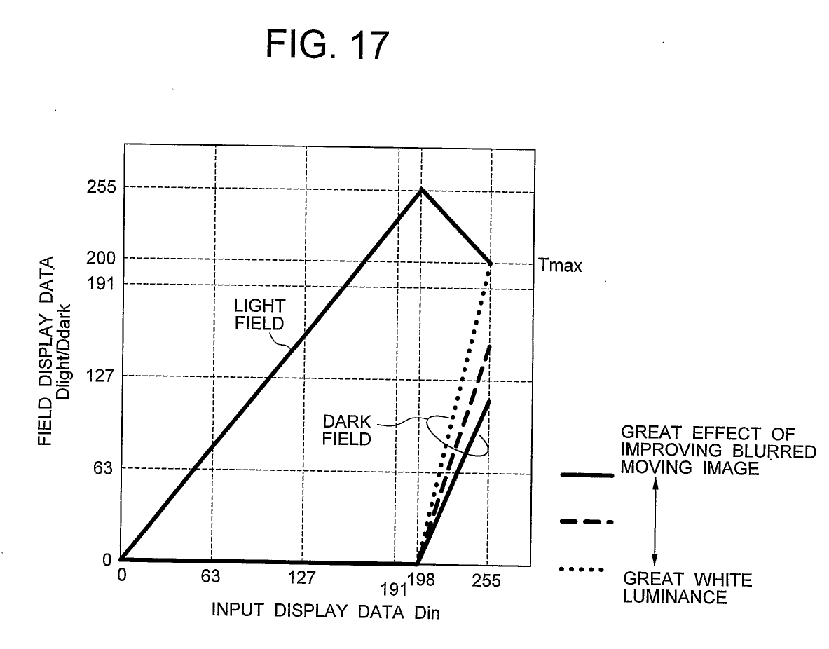

FIG. 17 shows the relation among the input display data 201, the light field display data 216 and the dark field display data 217 based on the conversion algorithm included in this embodiment. This embodiment is arranged to apply the voltage exceeding Tmax as the light field display data, on the higher tone side, reduce the light field display data as the dark field display data 217 becomes larger, and if the input display data is composed of 255 tones, set both of the light field and the dark one to Tmax.

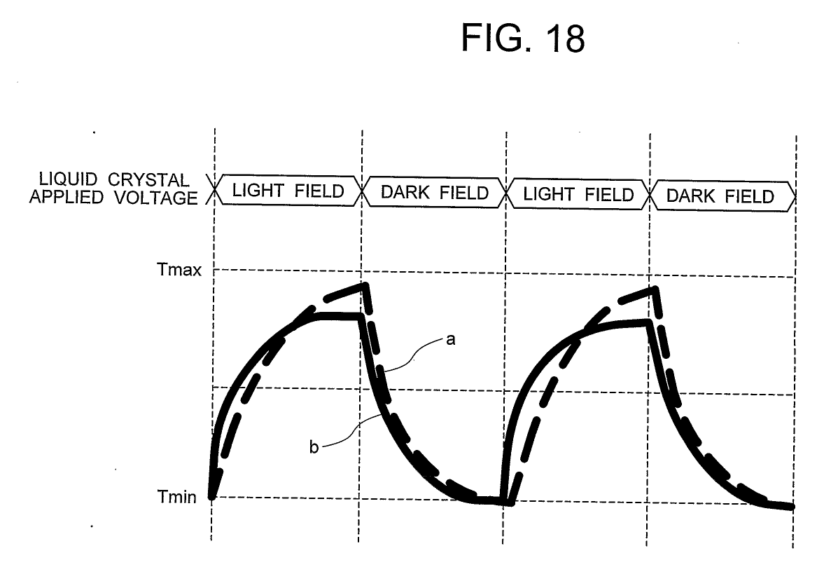

FIG. 18 shows a luminance response waveform appearing in the case of raising the liquid crystal driving voltage more than Vmax by applying the display device of this embodiment. In FIG. 18, a numeral a denotes a luminance response waveform appearing in the case of applying Vmax and a numeral b denotes a luminance response waveform appearing in the case of applying a higher liquid crystal driving voltage than Vmax.

Along the aforementioned drawings, the description will be oriented to the operation of the fourth embodiment to be executed when driven in two fields for the purpose of improving the blurred moving image.

In general, the rise response time of the liquid crystal display element is characterized to be shorter as the liquid crystal applied voltage is made higher. Hence, as shown in FIG. 9, in the case of applying the voltage Vmax that brings about Tmax, the static luminance becomes maximum. However, in the case of applying the driving system of improving the blurred moving image, since the light field in a halftone is raised from the dark field with a lower luminance than the light field unless the display data is changed, it is better to apply a higher voltage than Tmax for reducing the rise time. As a result, as shown in FIG. 18, the luminance response may be more quickly shifted to the stable area. This makes it possible to reduce dependency of the liquid crystal panel upon the other parameters of the response speed such as a temperature and a liquid crystal layer thickness.

Further, the rise of the dynamic luminance of the light field makes it possible to lower the dynamic luminance of the dark field according to the rise.

Lowering the luminance of the dark field leads to improving the blurredness of the moving image, which makes it possible to reduce the blurredness of the moving image on the halftone high luminance side.

Further, with respect to the dark field except the area where the data is converted into 0 tone, the conversion data of the dark field is raised and the conversion data of the light field is lowered in a manner to make the visual luminance curved in the set gamma characteristic. This makes it possible to suppress lowering of the luminance of the light field even on the higher tone side of the input display data and obtain the maximum luminance in the light field by executing the conversion so that the driving voltage of the light field reaches Tmax when the input display data specifies the 255 tones of the white luminance. Hence, the light field display data on a higher tone than a certain value is made lower as the display luminance becomes higher as shown in FIG. 17. At a time, when the input display data specifies the 255 tones, by setting the conversion data of the dark field to Tmax as shown in FIG. 17, the white luminance becomes maximum. By suppressing the conversion data to be Tmax or lower, though the white luminance is lower, the blurredness of the moving image may be improved even on the higher tone side.

### Fifth Embodiment

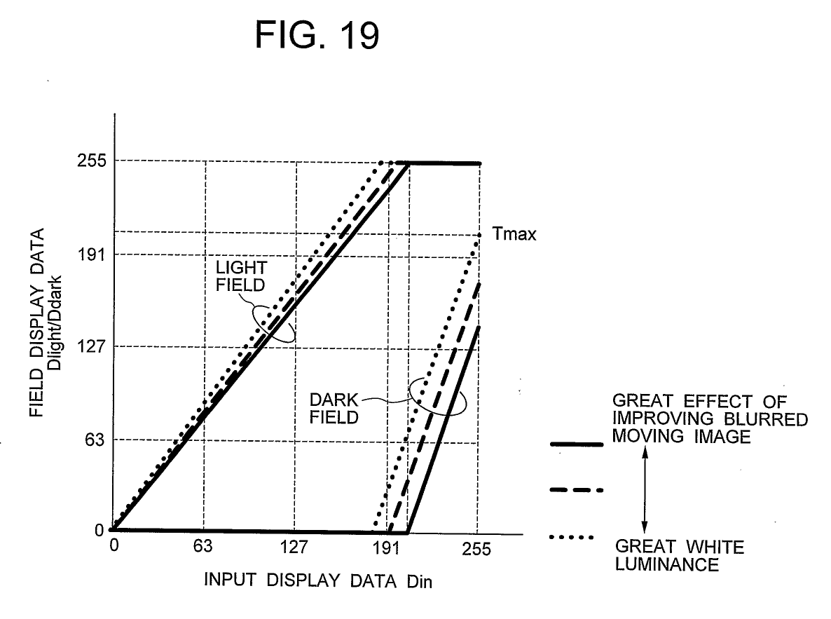

In the case of using the display device shown in FIG. 16, the different conversion algorithm of the light field display data and the dark field display data from that of the fourth embodiment will be described with reference to FIG. 19.

In the conversion algorithm shown in FIG. 19, the light field display data is converted so that a higher voltage than Tmax may be applied on the halftone. Unlike the fourth embodiment, in a case that the input display data indicates a higher tone, the similar conversion is carried out. That is, the light field display data is kept constant. The dark field display data is converted so that the target gamma characteristic of the display device may be obtained in combination with the dynamic luminance obtained by the light field display data converted as described above.

In this case, for achieving the maximum visual luminance appearing when the input display data specifies the 255 tones, it is just necessary to convert the dark field display data to be closer to Tmax. For improving the blurredness of the moving image in place of slightly lowering the visual luminance, it is just necessary to lower the data of the dark field display data.

As shown in FIG. 19, as the input display data is lowering the dark field display data for the 255 tones, it is necessary to reduce the overall luminance characteristic according to the gamma characteristic shown in the expression 1, while since the input display data does not change the static luminance of the light field display data for the 255 tones, as the maximum value of the dark field display data is made lower, the number of tones of the input display data in which the light field display data consists of 255 tones is made larger.

In the case of applying the foregoing conversion algorithm, as compared with the fourth embodiment, though the white luminance becomes lower, for each tone, one of the light field display data and the dark field display data is fixed to the 255 tones or 0 tone. Hence, the relation between the input display data and the luminance is not reversed on each tone, which makes the setting easier.

### Sixth Embodiment

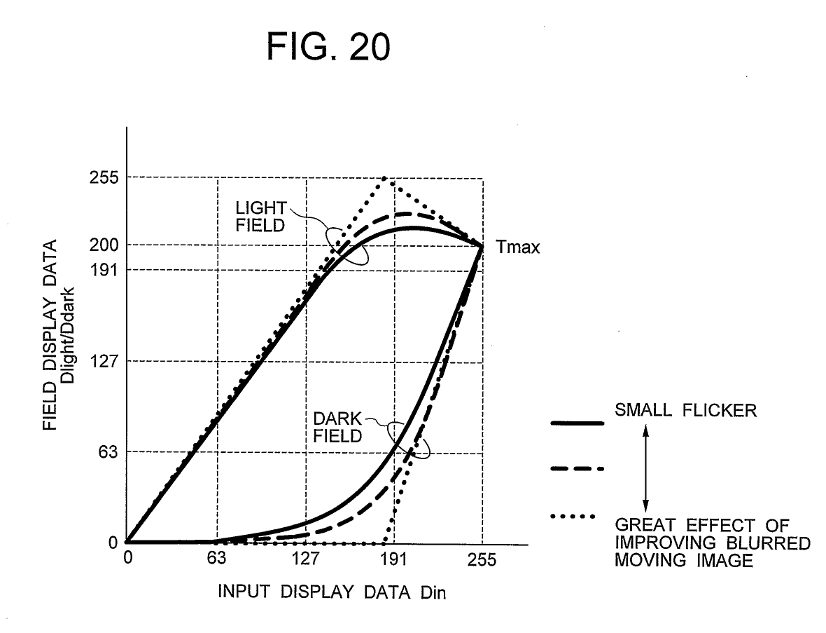

In turn, the description will be oriented to the different conversion algorithm of the light field display data and the dark field display data from that of the fourth or the fifth embodiment in the case that the liquid crystal driving voltages are respective in the normal driving system and the driving system of the present invention as shown in FIG. 16 with reference to FIG. 20.

In the conversion algorithm shown in FIG. 20, the light field display data is converted so that a higher voltage than Tmax may be applied on the halftone and the dark field display data is converted into a minimum value of 0 tone until the dynamic luminance of the light field becomes maximum in the state that the static luminance of the dark field is maximum. In the sixth embodiment, however, the dark field display data is converted into a larger tone than 0 tone in the lower tone at which the dynamic luminance of the light field becomes maximum.

In the foregoing conversion, like the case shown in FIG. 3, the maximum value of the difference between the dynamic luminance of the light field and the dynamic luminance of the dark field is made smaller that that of the fourth embodiment. This makes it possible for a viewer to have difficulty in visually recognizing the flickers even in the case that the input frame frequency is 50 Hz or less. Further, the display device with an excellent gamma characteristic may be offered by the same ground as that described in the third embodiment.

### Seventh Embodiment

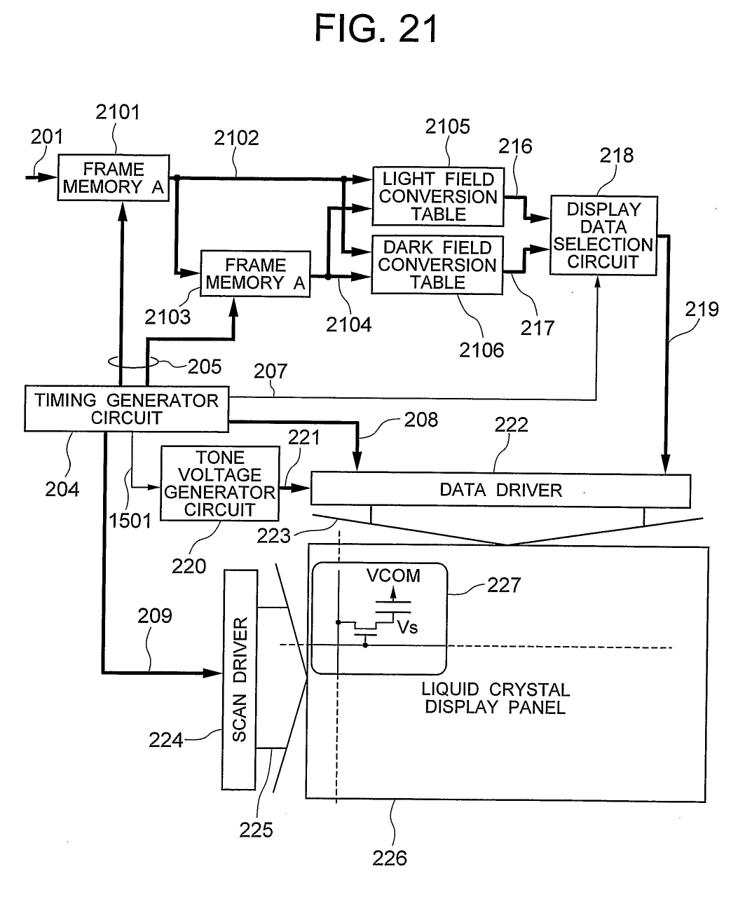

The method of improving the blurred moving image more by referring to the display data of a one-previous frame will be described with reference to FIGS. 21 to 25.

FIG. 21 shows an arrangement of this embodiment, in which figure the components having the same functions as those shown in FIG. 2 have the same reference numbers. A numeral 2101 denotes a frame memory A. Like the frame memory 210 shown in FIG. 2, the frame memory A allows at least the display data of one frame interval to be stored and serves to read and write data based on the memory control signal group 205. A numerical 2102 denotes memory read data A read out of the frame memory A based on the memory control signal group 205. A numeral 2103 denotes a frame memory B. A numeral 2104 denotes memory read data B. The memory read data A2102 is written in the frame memory B2103 based on the memory control signal group 205 and, one frame later, read out as the memory read data B2104. A numeral 2105 denotes a light field conversion table. A numeral 2106 denotes a dark field conversion table. The light field conversion tables and the dark field conversion tables having been described up to the sixth embodiment concern with only the display data of the current frame related with the concerned pixels. In this embodiment, the light field conversion table 2105 and the dark field conversion table 2106 perform the conversions based on the memory read data A2102 that indicates the display data of the current frame related with the concerned pixels and the memory read data B2104 that indicates the display data of the previous frame related with the concerned pixels.

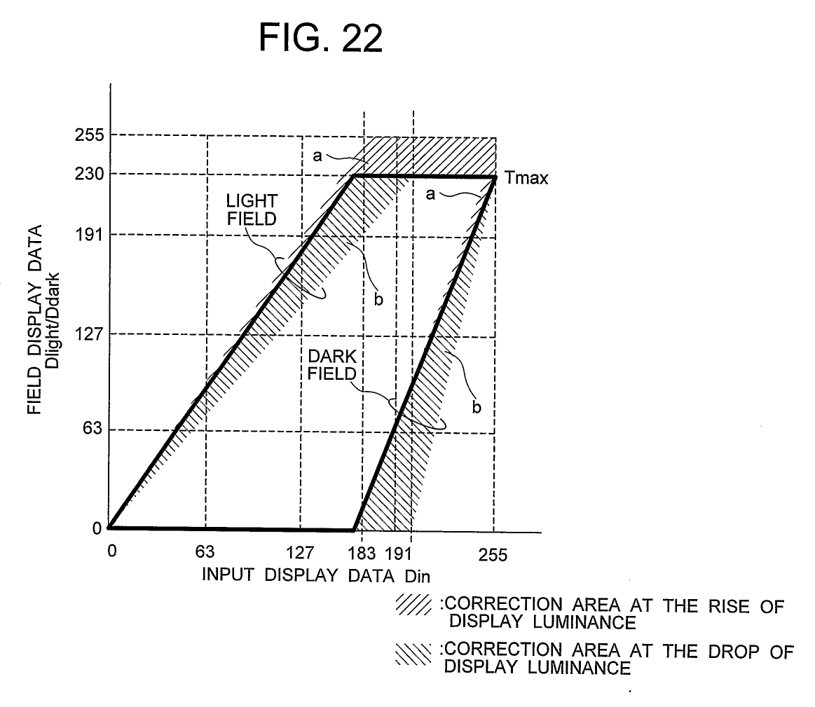

FIG. 22 shows the conversion algorithm included in the seventh embodiment, in which figure a real line denotes relation between the light field display data and the dark field display data against the input display data in the case that the input display data of the previous frame (N-th frame) is equal to the input display data of the current frame ((N+1)th frame). In FIG. 22, a numeral a denotes a correcting area appearing when a display luminance is made higher, while a numeral b denotes a correcting area appearing when a display luminance is made lower.

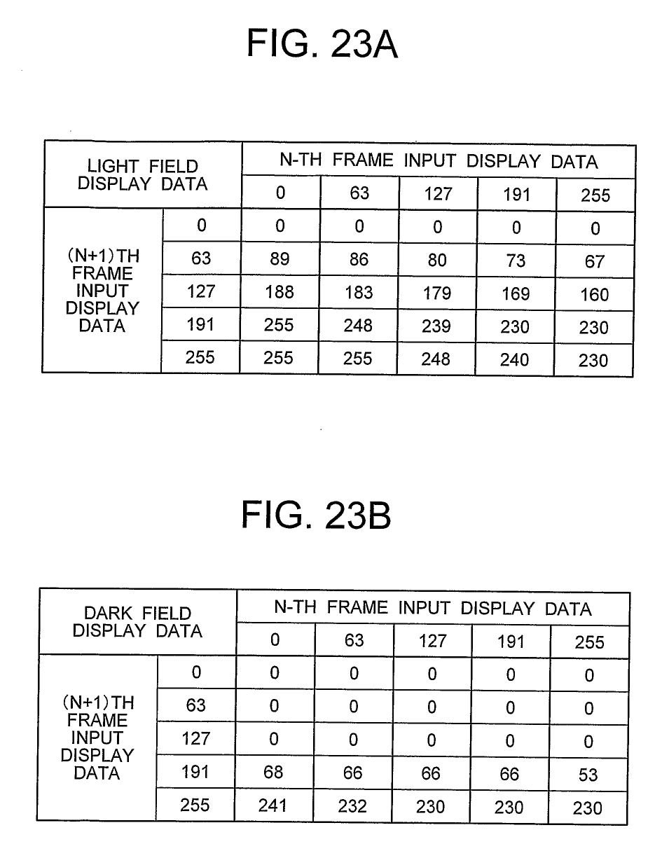

FIG. 23A and FIG. 23B show parts of the concrete conversion table included in the conversion algorithm shown in FIG. 22. FIG. 23A shows the light field conversion table and FIG. 23B shows the dark field conversion table.

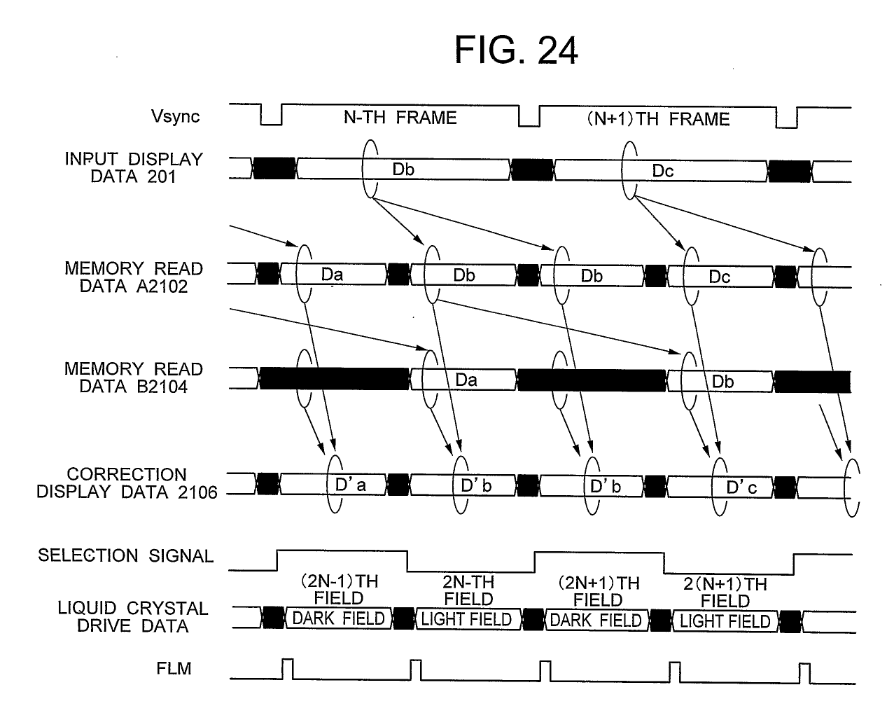

FIG. 24 shows relation among the I/O timings of the display data concerned with the frame memories A2101 and B2103.

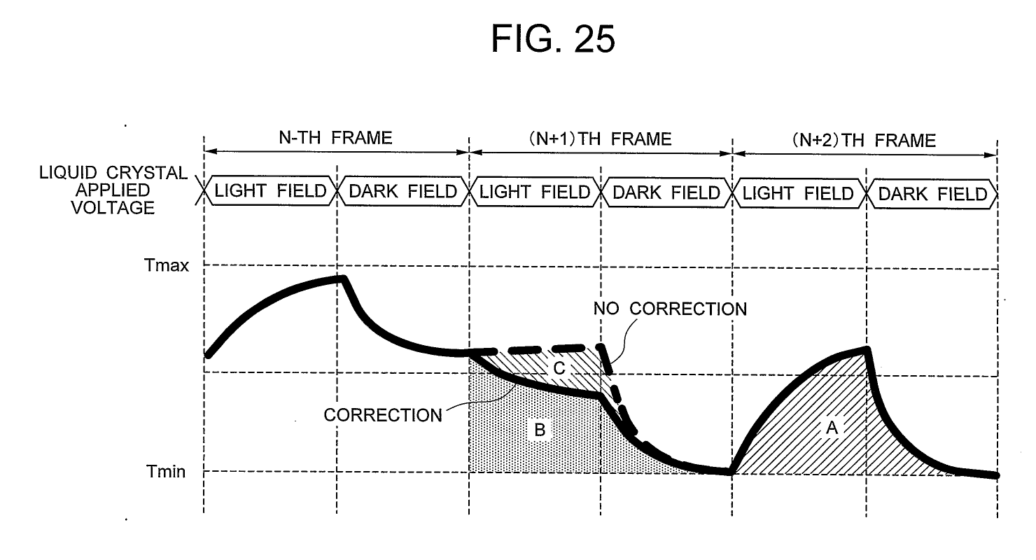

FIG. 25 is a luminance response waveform appearing in the case of applying this embodiment to the display device.

Along the aforementioned drawings, the seventh embodiment will be described.

The display data 201 inputted from the external system is written in the frame memory A2102 as shown in FIG. 24 and is read out as the memory read data A2102 twice in a one-frame interval. The read memory read data A2102 is transferred to the light field conversion table 2102 as well as the frame memory B2104. Like the frame memory A2102, the data is read out of the frame memory B2103 twice in a one-frame interval. The memory read data A2102 is transferred to the light field conversion table 2102. In this case, the memory read data A2102 and the memory read data B2104 concerns the information of the same pixel area.

Based on the memory read data A2102 and the memory read data B2104 transferred as above, the light field conversion table 2105 and the dark field conversion table 2106 perform their conversions.

In this embodiment, if the display data is a still image being unchanged between the current frame and the previous one, based on the memory read data A2102 and the memory read data B2104, the conversion is carried out as shown by a real line in FIG. 22. Herein, the light field display data is not converted into 255 tones even on the higher tone area (where the input display data is composed of 183 tones or more in FIG. 22) but into lower tones (230 tones in FIG. 22). The tone voltage at which Tmax is obtained at the converted tones is set to the voltage applied onto the liquid crystal display panel. The dark field display data is made to be suited to the gamma setting intended by the display luminance composed of the dynamic luminances of the light field and the dark field obtained by the foregoing conversion.

In turn, the description will be oriented to the change of the display data so that the display luminance may be raised from the pervious frame to the current frame.

In the seventh embodiment, the display is executed in two fields. In a case that the luminance is raised, based on the compared result, the light field display data is converted so that the luminance is made larger than the light field display data of the still image until the light field display data reaches the 255 tones. At a time, the dark field display data is converted so that the visual luminance of that case may be made equal to the visual luminance of the still image. Further, in a case that the luminance is short if the light field display data reaches the 255 tones, the dark field display data is converted so that the luminance is made larger than the dark field display data of the still image. Conversely, in the case of lowering the display luminance as compared with the previous frame, the dark field display data is converted so that the dark field display is made smaller than the luminance of the still image. Further, in a case that the visual luminance is lighter than the still image even if the dark field display data is the minimum value of 0 tone, the light field display data is converted so that the light field display data may be smaller than the luminance of the still image.

The concrete example of the foregoing conversion algorithm will be described with reference to FIG. 23. For example, in a case that the input display data 201 of the previous frame and the current frame specifies the 191 tones, the light field display data is specified as the 230 tones that correspond to Tmax as shown in FIG. 23A and the dark field display data is specified as the 66 tones that are matched to Tmax as shown in FIG. 23B. The input display data 201 of the previous frame specifies the 0 tone and the input display data 201 of the current frame is specified as the 191 tones. That is, when the display luminance is raised, the light field display data is the 255 tones at which the liquid crystal display applied voltage becomes maximum as shown in FIG. 23A. In order to correct for a shortage of the visual luminance, the dark field display data is specified as the 68 tones as shown in FIG. 23B. The input display data 201 of the previous frame is specified as the 255 tones and the input display data 201 of the current frame is specified as the 191 tones. In the case of lowering the display luminance, the light field display data keeps the 230 tones and the dark field display data is specified as the 53 tones as shown in FIG. 23B.

The foregoing effect of performing the correction with the display data of the previous frame will be described with reference to FIG. 25. FIG. 25 shows the luminance response waveform appearing in the case that the tones indicated by the display data is made lower in the shift of the N-th frame to the (N+1)th frame. A real line denotes the correction by referring to the display data of the N-th frame, while a dotted line denotes no correction. To the luminance response as shown in FIG. 25, the visual luminance may be approximated to the area indicated by oblique lines of FIG. 25. Hence, for a still image, the area A indicated at the (N+2)th frame corresponds to the visual luminance, while if no correction is carried out, the area of the (N+1)th frame is made to correspond to B+C because of being influenced by the luminance of the N-th frame dark field. Since this area is different from the area A, this area has a different visual luminance. On the other hand, as indicated in this embodiment, by referring to the display data of the previous frame, the area of the (N+1)th frame is made to be B. By converting the light field display data and the dark field display data so that the relation of B=A is established, the blurredness of the moving image may be further reduced.

Moreover, the conversion algorithm of the seventh embodiment is not a sole method for converting the light field display data and the dark field display data so that the relation of B=A is established. For example, only the light field conversion table or the dark field conversion table may be used for the conversion. Further, the frame memory B2103 does not necessarily store all the bits of the display data. For example, only the lower bits of the display data may be reduced in the frame memory B2103. That is, only the upper bits of the display data may be stored in the frame memory B2103. This makes it possible to reduce the capacity of the frame memory B. Further, the seventh embodiment concerns with the conversion algorithm of the still image shown in FIG. 22. The conversion algorithm is not limited to this format. For example, as shown in FIG. 15, the dark field display data may be specified to any tone except 0 tone before the light field display data obtains a maximum value.

### Eighth Embodiment

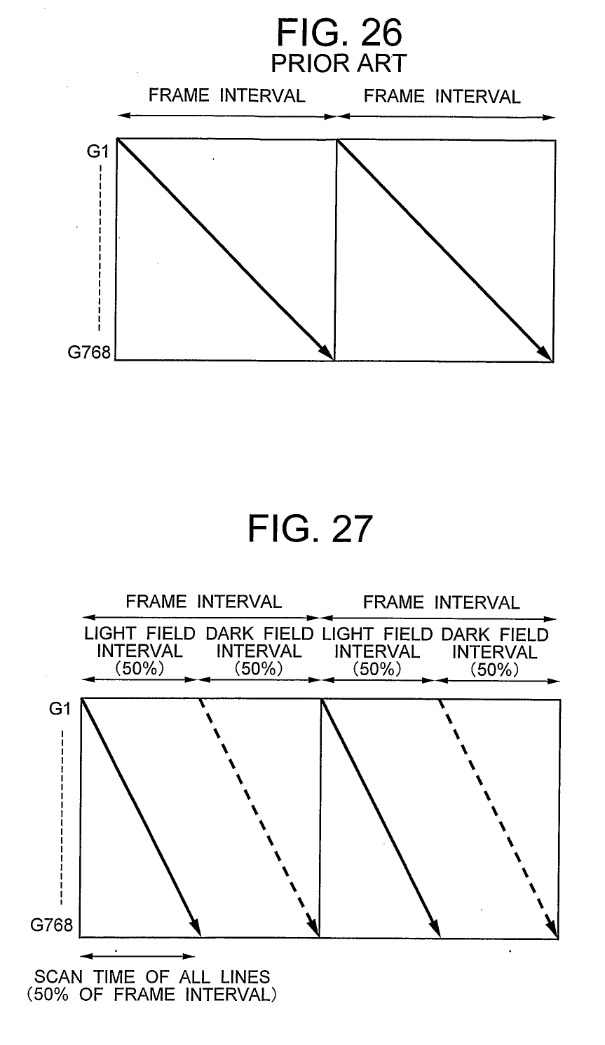

In turn, with reference to FIGS. 26 to 29, the description will be oriented to the driving circuit that is arranged to reduce the data capacity of the frame memory included in the driving system for improving the blurred moving image as described with respect to the first to the seventh embodiments. The description of the eighth embodiment will be expanded on the assumption that the resolution of the liquid crystal display panel is WXGA which consists of a horizontal resolution 1366 lines×RGB and the vertical resolution 766 lines.

FIG. 26 shows the scan operation of the conventional liquid crystal driving device. The gate lines of the liquid crystal display panel are sequentially selected from G1 to G768 in a one-frame interval. Concretely, the head line G1 of the gate lines is selected and the liquid crystal drive voltage corresponding with the display data of the G1 line is applied in the G1 line. Then, the line G2 is selected and the voltage is similarly applied. Later, the gate lines are sequentially selected one line by one line, and then the last G768 line is selected and the liquid crystal drive voltage corresponding with the display data of the G768 line is applied in the last line. This scan operation results in selecting all the lines in a one-frame interval and completing the display of the overall screen. In the next frame, likewise, the head line G1 of the gate line is selected, the gate lines are sequentially selected one line by one line, and the last line G768 is selected. This scan operation results in selecting all the lines in a one-frame interval.

On the other hand, the driving system described with respect to the first to the seventh embodiments of the present invention as shown in FIG. 27 operates to divide a one-frame interval into two fields of the light and the dark fields and select all the lines in each field for improving the blurred moving image. It means that each line is selected twice in a one-frame interval. In the light field interval shown in FIG. 27, the head line G1 of the gate lines is selected and the liquid crystal drive voltage based on the display data converted into the light field data of the G1 line is applied in the head line G1. Then, the line G2 is selected, and later the gate lines are sequentially selected one line by one line. Lastly, the last line G768 is selected and the liquid crystal drive voltage corresponding with the display data of the G768 line is applied in the last line G768. Further, in the dark field interval, the head line G1 of the gate line is selected and the liquid crystal drive voltage based on the display data converted into the dark field data of the G1 line is applied in the head line G1. Then, the line G2 is selected and later the gate lines are sequentially selected one line by one line. Lastly, the last line G768 is selected and the liquid crystal drive voltage corresponding with the display data of the line G768 is applied in the last line. As such, since the frequency of writing the display data on the liquid crystal display panel is different from the frequency of the inputted display data, it is necessary to temporarily store the display data in the frame memory and read the display data on the write timing. Hence, the driving circuit system needs to provide the frame memory as shown in FIGS. 2, 16 and 21.

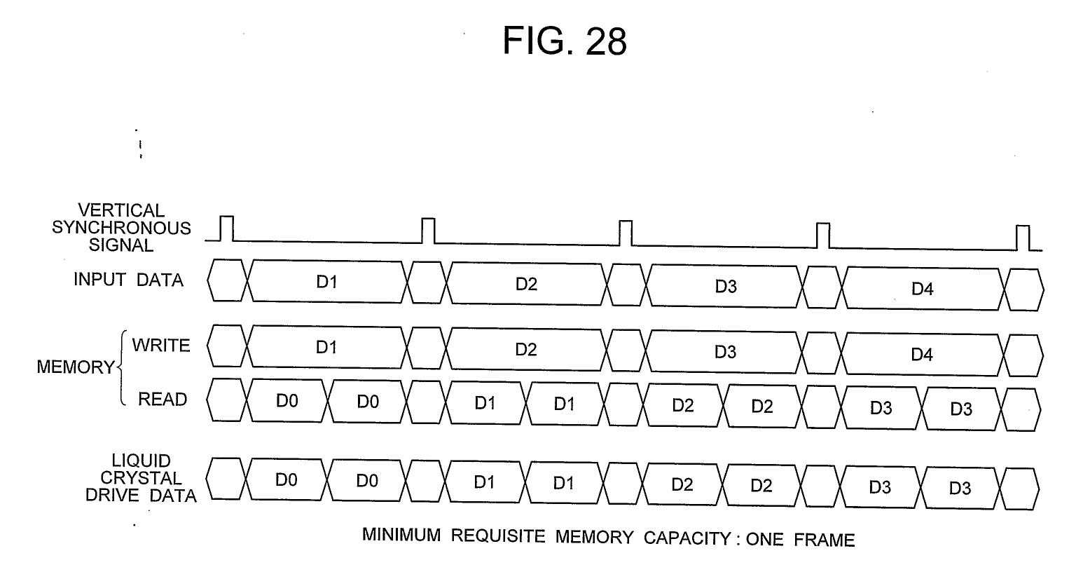

In turn, the description will be oriented to the control timing and the minimum requisite memory capacity of the frame memory included in the first to the sixth embodiments with reference to FIG. 28. As shown in FIG. 28, the input data D1, D2, D3 and D4 of one frame is sequentially inputted and written in the frame memory. The written display data is held in a one-frame interval. Then, in the next frame, the display data is read at a doubled frequency and the display data is converted into the light field data and the dark field data. Then, the liquid crystal drive voltage based on the light or the dark field data is applied on the liquid crystal display panel. Hence, the minimum requisite memory capacity is made to correspond to one frame of a screen resolution.

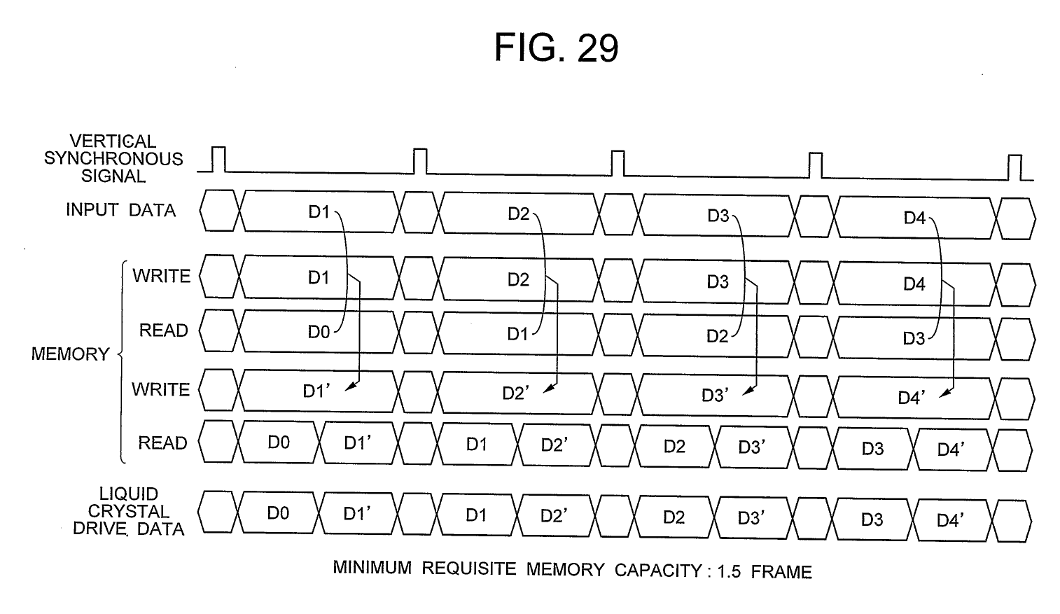

In turn, with reference to FIG. 29, the description will be oriented to the control timing and the minimum requisite memory capacity of the frame memory in the case of correcting the display data by referring to the display data of a one-previous frame and thereby improving the blurred moving image more. As shown in FIG. 29, the input data D1, D2, D3 or D4 of one frame is sequentially inputted and written in the frame memory. The written display data is held in a one-frame interval. In the next frame interval, the display data is read at a frame period (which means a vertical synchronous signal). The correction display data (D1′, D2′, D3′, D4′) for correcting the response between the frames are generated from the input data and the previous frame data read from the memory and then are temporarily written in the frame memory.

Then, a half frame later, the corrected display data (D1′, D2′, D3′, D4′) is read at a doubled frequency, converted into the light field data, and then the liquid crystal drive voltage based on the light field data is applied on the liquid crystal display panel. Further, in the next dark field, the display data is read a half frame later and is converted into the dark field data. The liquid crystal drive voltage based on the dark field data is applied on the liquid crystal display panel. Hence, the minimum requisite memory capacity corresponds to 1.5 frame of a screen resolution.

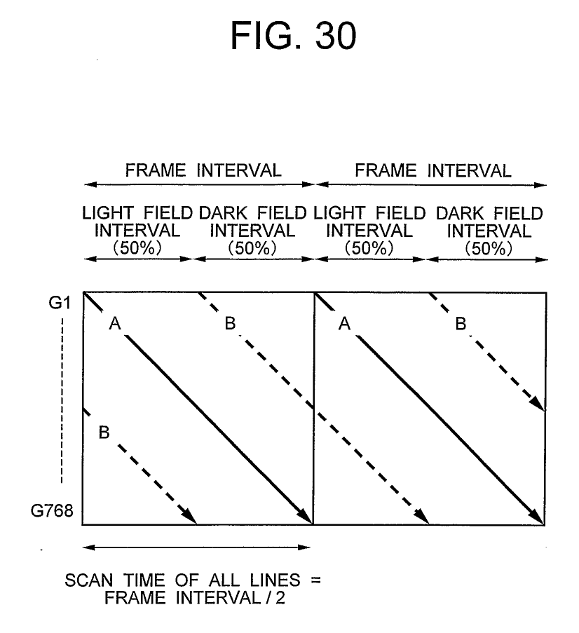

In turn, the description will be oriented to the driving circuit that may reduce the data capacity of the frame memory of the driving system for improving the blurred moving image as described with respect to the first to the seventh embodiments with reference to FIGS. 30 to 36.

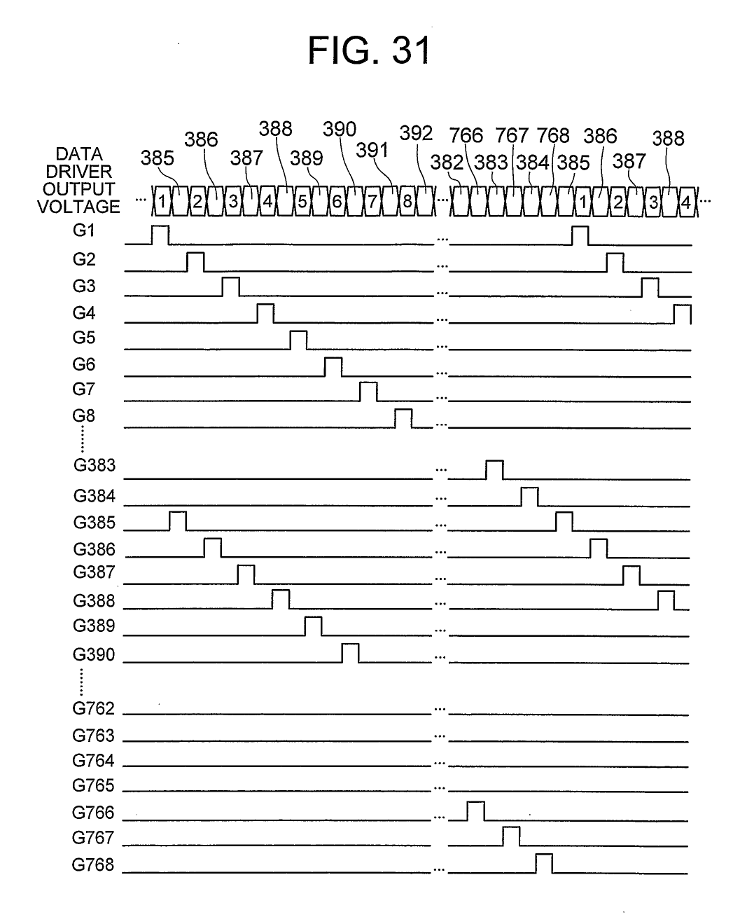

FIG. 30 shows the driving system that may reduce the memory capacity more than the driving systems of the first to the seventh embodiments. Though a one-frame interval is divided into the light field interval and the dark field interval for improving the blurred moving image, this driving system operates to alternately select each field for selecting all the lines, so that each line may be selected twice in a one-frame interval. In FIG. 30, the scan selection A of the light field and the scan selection B of the dark field are alternately carried out on each line. This drive operation will be described in detail with reference to FIG. 31.

In FIG. 31, G1 to G768 denote the gate lines of the liquid crystal display panel with a vertical resolution of 768 lines. The scan selection A of the light field is executed to select the gate line G1, the scan selection B of the dark field is executed to select the gate line G385, the scan selection A of the light field is executed to select the gate line G2, . . . and the scan selection B of the dark field is executed to select the gate line G385. That is, each line of the upper half (the first line group consisting of the gate lines G1 to G384) of the liquid crystal display panel and the lower half (the second line group consisting of the gate lines G385 to G768) thereof are alternately and sequentially selected. Further, in the first period of the one-frame interval, the light field data is displayed on the upper half of the liquid crystal display panel and the dark field data is displayed on the lower half of the display panel. In the second period of the one-frame interval, the dark field data is displayed on the upper half of the display panel and the light field data is displayed on the lower half of the display panel. By sequentially performing this operation, in a one-frame interval, each gate line is selected twice, that is, by the scan selection A of the light field and by the scan selection B of the dark field. Herein, focusing attention to the gate line G1, the gate line G1 is selected by the scan selection A of the light field and then is selected about a half of a frame period later by the scan selection B of the dark field. Shifting to the next frame, the scan selection A of the light field is executed about a half of a frame period later. This operation is continued. Likewise, another gate line is selected by the scan selection A of the light field and then selected about a half of a frame period later by the scan selection B of the dark field. Shifting to the next frame, the scan selection A of the light field is executed about a half of a frame period later. This operation is continued. Hence, like the double-speed drive shown in FIG. 27, in a one-frame interval, the light field interval and the dark field interval may be executed.

As shown in FIG. 31, at the head of a one-frame interval, the scan selection A of the light field is executed to select the head line G1 of the gate line and apply the liquid crystal drive voltage based on the display data converted into the light field data of the G1 line in the line G1. Then, the scan selection B of the dark field is executed to select the gate line G385 and apply the liquid crystal drive voltage based on the display data converted into the dark field data of the line G385 in the gate line G385. Then, the line G2 is selected by the scan selection A of the light field, and later each gate line is repetitively selected by the scan selection A of the light field and the scan selection B of the dark field. As such, since the frequency at which the display data is written on the liquid crystal display panel is different in phase from the frequency of the inputted display data, it is necessary to temporarily store the display data in the frame memory and read the display data on the write timing. Hence, the driving circuit system needs to provide the frame memory as shown in FIGS. 2, 16 and 21.

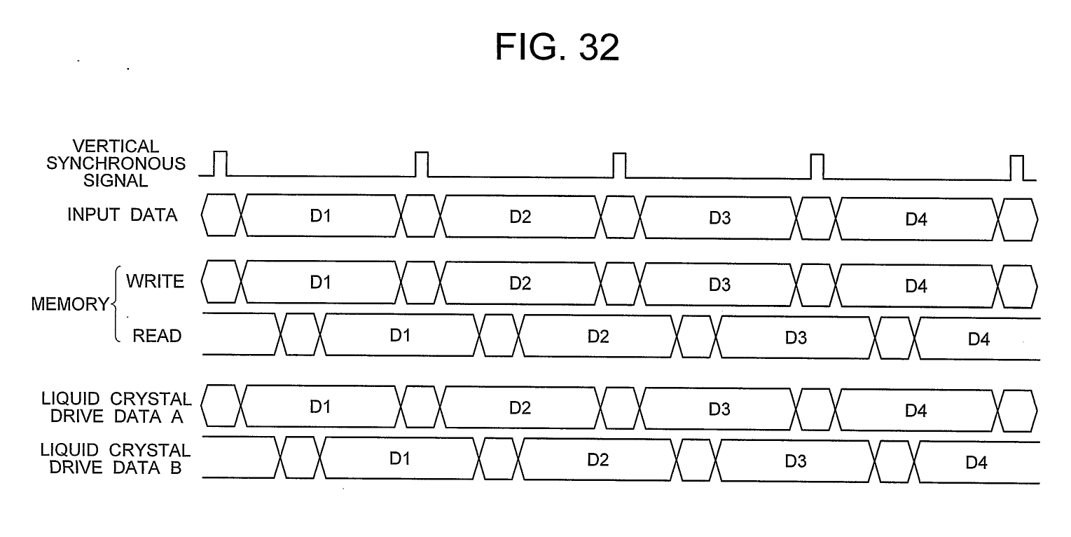

In turn, the description will be oriented to the control timing and the minimum requisite memory capacity of the frame memory described with respect to the first to the sixth embodiments with reference to FIG. 32. As shown in FIG. 32, the input data D1, D2, D3 or D4 of one frame is sequentially inputted and written in the frame memory. The written display data is held during a half of a frame. After a half of a frame interval, the written data is read at a frame frequency and is converted into the light field data and the dark field data. Then, the liquid crystal drive voltage based on the converted data is applied on the liquid crystal display panel. Hence, the minimum requisite memory capacity is a half of a screen resolution, that is, a half capacity.

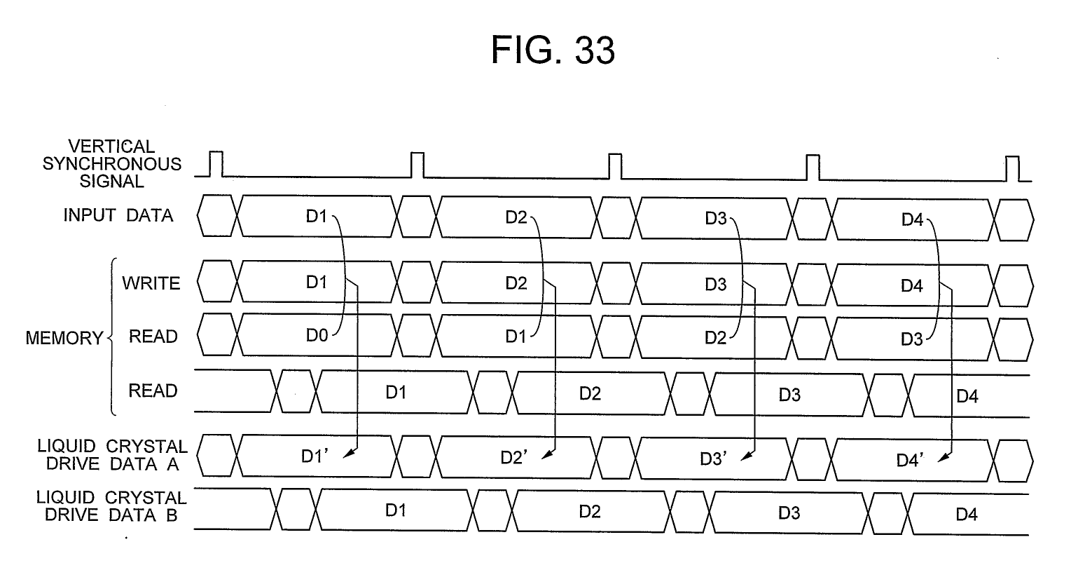

In turn, with reference to FIG. 33, the description will be oriented to the control timing and the minimum requisite memory capacity of the frame memory for correcting the display data by referring to the display data of a one-previous frame and more improving the blurred moving image by this correction as described with respect to the seventh embodiment. As shown in FIG. 33, the input data D1, D2, D3 or D4 of one frame is sequentially inputted and then written in the frame memory. The written display data is held during a one-frame interval. In the next frame, the display data is read out at a frame period. Then, the correction display data (D1′, D2′, D3′ and D4′) for correcting the response between the frames is generated from the input data and the previous frame data read from the memory and then converted into the light field data. The liquid crystal drive voltage (liquid crystal drive data A) based on the converted data is applied on the liquid crystal display panel. Further, after a half of a frame period, in the dark field, the display data of the memory is read a half of a frame period later and converted into the dark field data. Then, the liquid crystal drive voltage (liquid crystal drive data B) based on the dark field data is applied on the liquid crystal display panel. Hence, the minimum requisite memory capacity corresponds to 1.0 frame of a screen resolution.

As described above, the light field scan selection and the dark field scan selection, described with respect to the eighth embodiment, are alternately executed for each line. This makes it possible to reduce the frame memory capacity and thereby make the driving circuit system less costly.

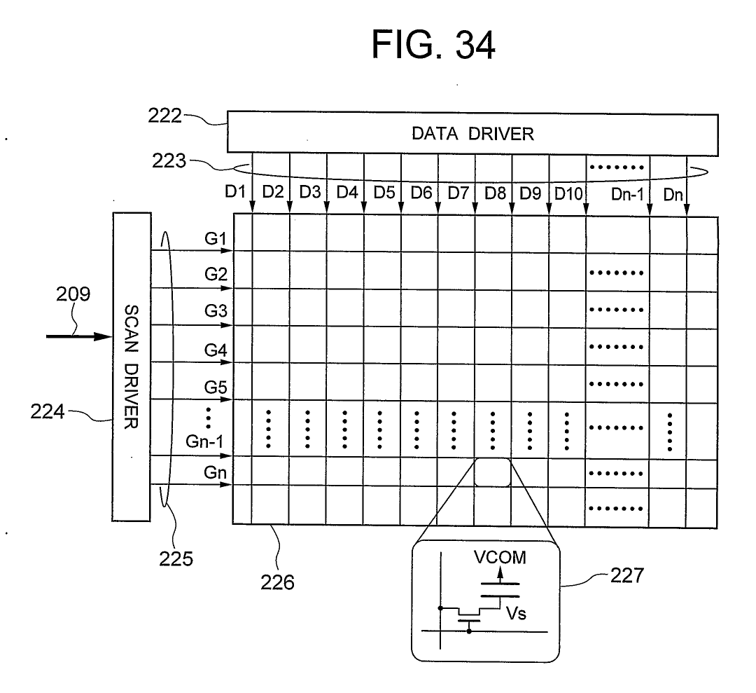

In turn, the circuit arrangement of this embodiment will be described with reference to FIGS. 34 to 36.

FIG. 34 shows a detailed arrangement of the driving circuit of the liquid crystal display panel, which is the same as that shown in FIGS. 2, 16 and 21. In FIG. 34, a numeral 222 denotes a data driver that applies the liquid crystal drive voltage based on the display data into the liquid crystal display panel. A numeral 224 denotes a scan driver that selectively scans the gate lines. A numeral 226 denotes a liquid crystal display panel having data lines D1 to Dn and gate lines G1 to Gn located on a glass substrate in a matrix format. A numeral 227 denotes a pixel composed of a TFT switch connected with the data lines and the gate lines. A numeral 209 denotes a control signal of the scan driver 224.

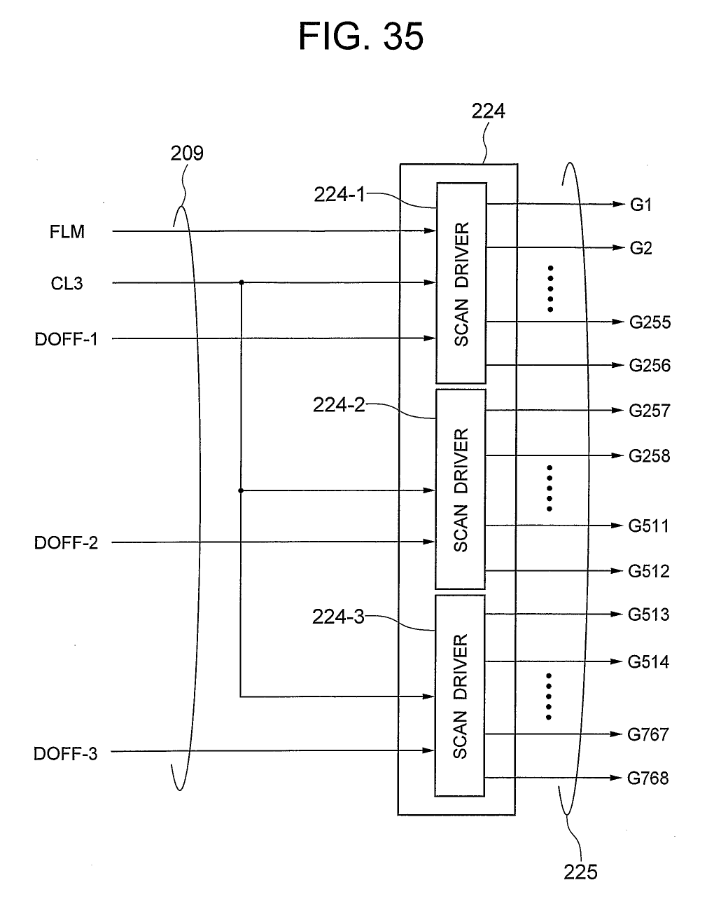

FIG. 35 shows a more detailed arrangement of the scan driver 224. Numerals 224-1 to 224-3 denote scan drivers each composed of one LSI. Each scan driver corresponds with 256 outputs. The combination of three scan drivers may correspond with a vertical resolution of 768 lines. In this embodiment, the description will be expanded on the assumption that the liquid crystal display panel has a vertical resolution of 768 lines. The control signal 209 of the scan driver is composed of a frame synchronous signal FLM that indicates the head of a frame, a scan timing signal CL3 that causes the scan driver to be selectively operated, and a non-selection signals DOFF-1 to DOFF-3 that causes the output of the scan driver to be in a non-selective state. The high level of the frame synchronous signal FML is read on the rise of the scan timing signal CL3, and the selecting operation is sequentially shifted on the rise of the scan timing signal CL3. DOFF-1 to DOFF-3 are respectively controlled by the three scan drivers so that the output of the scan driver may be caused to be in the non-selective state (at low level) when DOFF-1 to DOFF-3 are at high level or in the selective state (at high level) when DOFF-1 to DOFF-3 are at low level.

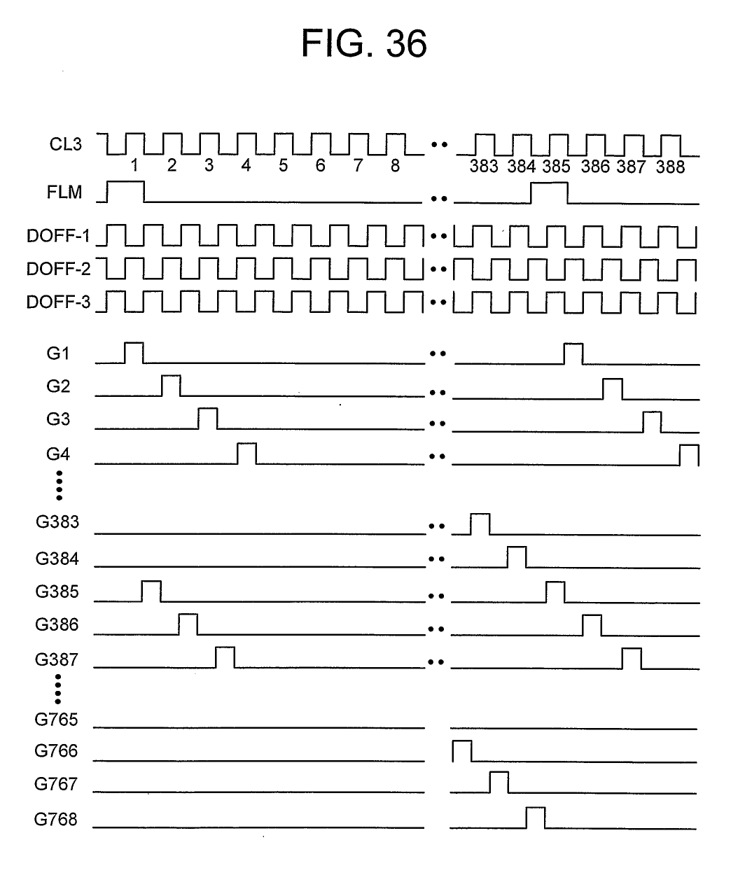

FIG. 36 shows the timing chart of the scan selection. Then, the scan selection will be described below. The high level of the frame synchronous signal FLM is read on the rise of the pulse 1 of the scan timing signal CL3. The scan driver 224-1 selects the gate line G1. The non-selective signal DOFF-1 is at low level in the first half of the period of the signal CL3 and at high level in the second half thereof. The gate line G1 is selected in the first half interval of the period of the CL3. At this time, since the non-selective signal DOFF-2 for the scan driver 224-2 is at high level in the first half of the period of the CL3 and at low level in the second half thereof, the scan driver 224-2 selects the gate line G385 in the second half of the period of the CL3. On the pulse 2 of the scan timing signal CL3, the gate line G2 is selected in the first half of the period of the CL3 and the gate line G386 is selected in the second half of the period of CL3. Subsequently, likewise, the scan selection is repeated in the sequence of the gate lines G3, G387, G4 and G388. At a time, the light field selection scan A shown in FIG. 30 corresponds with the scan selection of the gate lines G1, G2, G3 and G4, while the dark field selection scan B corresponds with the scan selection of the gate lines G385, G386, G387 and G388.

Further, on the rising timing of the pulse 385 of the scan timing signal CL3 that corresponds to about a half of a frame interval, the high level of the signal FLM is read and the gate line G1 is selected.

The non-selective signal DOFF-1 is at high level in the first half of the period of the signal CL3 and at low level in the second half thereof. The gate line G1 is selected in the second half interval thereof. A this time, since the non-selection signal DOFF-12 signal is at low level in the first half of the period of the signal CL3 and at high level in the second half thereof, the scan driver 224-2 selects the gate signal G385 in the first half thereof. On the next pulse 386 of the scan timing signal CL3, the gate G386 is selected in the first half of the period of the signal CL3 and the gate signal G2 is selected in the second half thereof. Subsequently, likewise, the scan selection is repeated in the sequence of the gate lines G387, G3, G388 and G4. At this time, the light field selection scan A shown in FIG. 30 corresponds with the scan selection of the gate lines G385, G386, G387 and G388, while the dark field selection scan B corresponds with the scan selection of the gate lines G1, G2, G3 and G4.

As described above, the frame synchronous signal FLM, the non-selection signals DOFF-1, DOFF-2 and DOFF-3 are controlled in synchronous to the scan timing signal CL3 of the scan driver, so that the light field selection scan A and the dark field selection scan B shown in FIGS. 30, 31 and 36 may be alternately executed line by line.

Instead, the upper half and the lower half of the liquid crystal display panel may be alternately selected plural lines by plural lines (for example, two lines, three lines or four lines). That is, after the plural lines of the upper half are collectively selected, the plural lines of the lower half may be collectively selected. The liquid crystal display panel may be divided vertically into two, three or four.

In a case that all the lines (all the gate lines) of the liquid crystal display panel are divided into L parts (L being 2 or more but a smaller integer than the number of all lines composing the liquid crystal display panel), it is preferable to divide a one-frame interval into L intervals and to convert one set of display data into L field display data. At least one of L-divided field display data parts is the dark field data. In addition, this division may be equal division or non-equal division.

### Ninth Embodiment

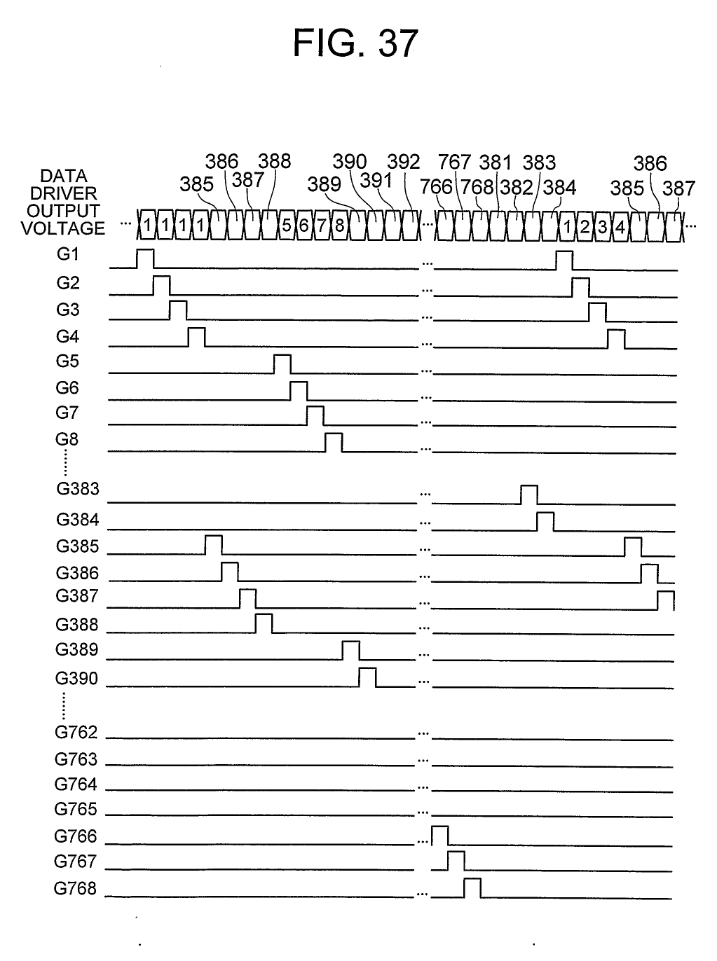

In turn, the description will be oriented to the driving system of the ninth embodiment with reference to FIGS. 37 to 40. This driving system is arranged to execute the scan selection of the light field and the dark field alternately four lines by four lines in the alternate scan selection of the light field and the dark field as described with respect to the eighth embodiment. This alternate scan selection makes it possible to improve the characteristic of applying the liquid crystal drive voltage onto the liquid crystal display panel, thereby keeping the display image highly excellent. In FIG. 37, the scan selection A of the light field is executed to sequentially select the consecutive four lines of the adjacent gate lines G1, G2, G3 and G4 from the head of the frame. Then, the scan selection B of the dark field is executed to sequentially select the consecutive four lines of the adjacent gate lines G386, G387 and G388 from the gate line 385 located around the center of the liquid crystal display panel. Further, the scan selection A of the light field is executed sequentially select the consecutive four lines of the gate lines G6, G7 and G8 from G5, and the scan selection B of the light field is executed sequentially select the consecutive four lines of the gate lines G390, G391 and G392 from G389. As described above, the scan selection A of the light field or the scan selection B of the dark field shown in FIG. 30 is sequentially executed for adjacent four lines.

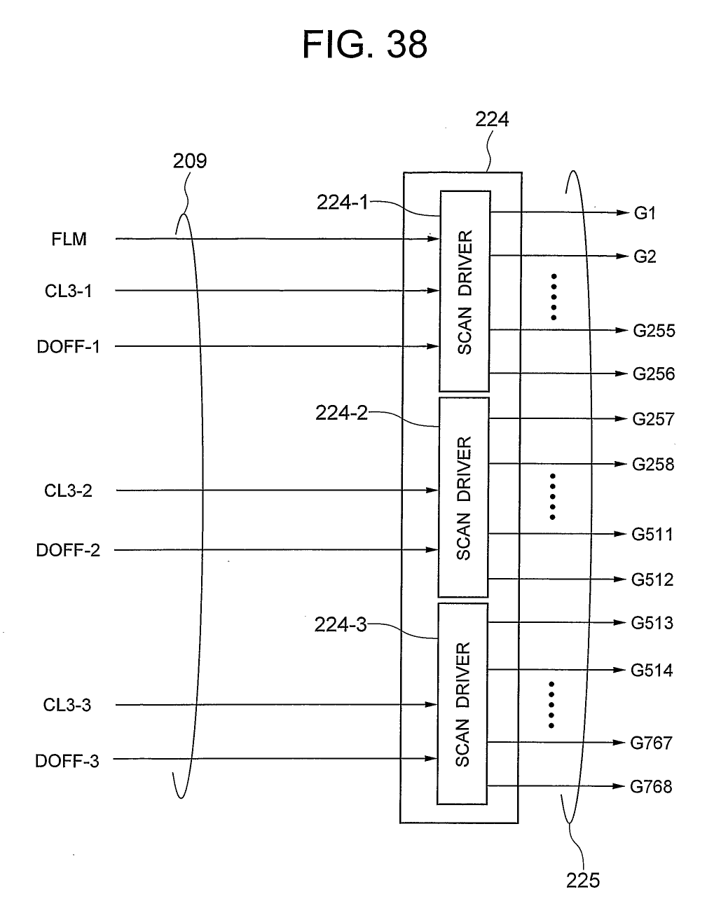

Next, the arrangement of the scan driver will be described with reference to FIGS. 34 and 38. In this embodiment, like the eighth embodiment, the circuit arrangement shown in FIG. 34 serves to drive the liquid crystal display panel. In this embodiment, since the arrangement of the scan driver 224 is different from that of the eighth embodiment, the arrangement of the scan driver will be described with reference to FIG. 38. FIG. 38 shows a more detailed arrangement of the scan driver 224. Numerals 224-1 to 224-3 denote scan drivers each composed of one LSI. Each scan driver corresponds with 256 outputs. The combination of three scan drivers may correspond with a vertical resolution of 768 lines. In this embodiment, the description will be expanded on the assumption that the liquid crystal display panel has a vertical resolution of 768 lines. The control signal 209 of the scan driver is composed of a frame synchronous signal FLM that indicates a head of a frame, scan timing signals CL3-1 to CL3-3 that causes the scan driver to be selectively operated, and non-selection signal DOFF-1 to DOFF-3 that causes the output of the scan driver to be in the non-selective state. The non-selection signals DOFF-1 to DOFF-3 are served to respectively control the three scan drivers 224-1 to 224-3. Hence, the three systems are provided. On the rise of the scan timing signal CL3-1, the high level of the frame synchronous signal FLM is read. Then, on the rises of the scan timing signals CL3-1 to C13-3, the selection is sequentially being shifted. The non-selection signals DOFF-1 to DOFF-3 are respectively controlled by three scan drivers so that the output of the scan driver is caused to be in a non-selective state (at low level) when DOFF-1 to DOFF-3 are at high level or in a selective state (at high level) when DOFF-1 to DOFF-3 are at low level.

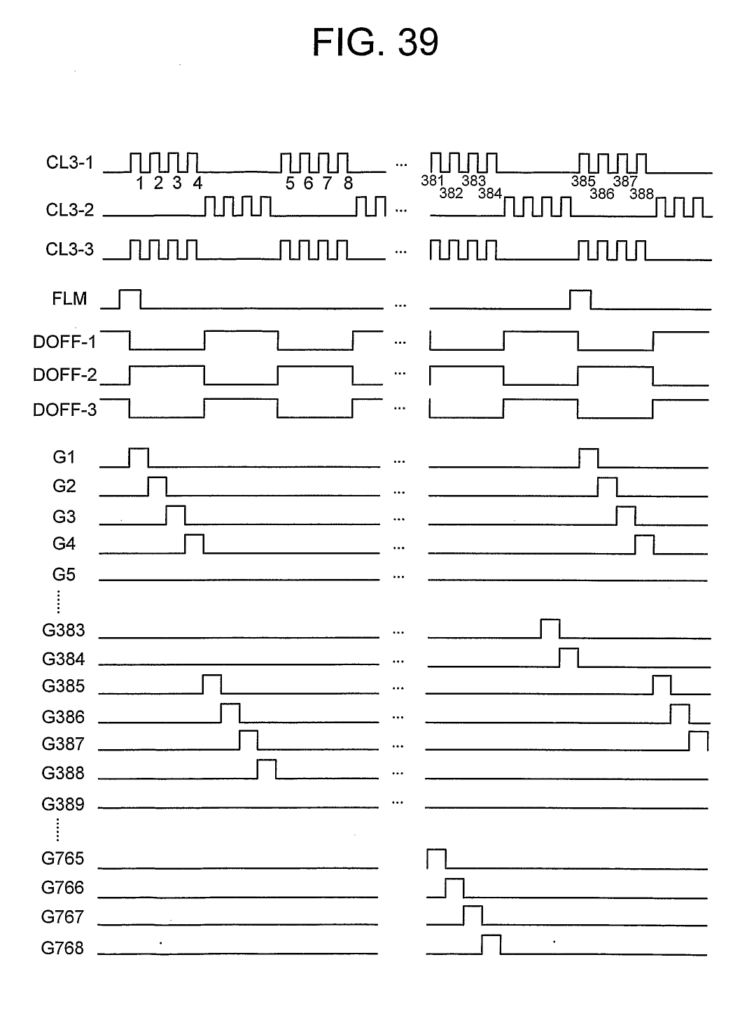

FIG. 39 shows the timing chart of the scan selection, with reference to which, the scan selection will be described below. The high level of the frame synchronous signal FLM is read on the rise of the pulse 1 of the scan timing signal CL3-1, on the rise of the pulse 2 of the scan timing signal CL3-1, the scan selection is shifted so that the scan driver 224-1 may select the gate line G2. Further, on the rise of the pulse 3 of the scan timing signal CL3-1, the scan selection is shifted so that the scan driver 224-1 may select the gate line G3. Then, on the rise of the pulse 4 of the scan timing signal CL3-1, the scan selection is shifted so that the scan driver 224-1 may select the gate line G4. At this time, the non-selection signal DOFF-1 stays at low level in four periods of the signal CL3 so that the output of the scan driver 224-1 may be effective. As such, the consecutive four gate lines are sequentially selected. Then, on the rise of the scan timing signal CL3-2, the scan driver 224-2 selects the gate line G385, and on the next rise of the scan timing signal CL3-2, the scan selection is shifted so that the scan driver 242-2 may select the gate line G386. Likewise, the scan driver 224-2 selects the gate line G387 and G388 sequentially and continuously. At this time, the non-selection signal DOFF-2 is at low level during four periods of the signal CL3 so that the output of the scan driver 224-2 may be effective. Subsequently, likewise, the scan selection is repeated in the sequence of the gate lines G5, G6, G7, G8, G389, G390, G391 and G392. In this case, the light field selection scan A shown in FIG. 30 correspond with the scan selection of the gate lines G1, G2, G3 and G4, while the dark field selection scan B corresponds with the scan selection of the gate lines G385, G386, G387 and G388.

Further, on the rise timing 385 of the scan timing signal CL3-1 that corresponds to about a half of a frame period, the high level of the FLM is read, and the scan selection is shifted on the rise of the pulse 386 of the scan timing signal CL3-1 so that the gate line G2 may be selected by the scan driver 224-1. Then, on the rise of the pulse 387 of the scan timing signal CL3-1, the scan selection is shifted so that the gate line G3 may be selected by the scan driver 224-1. Next, on the rise of the pulse 4 of the scan timing signal CL3-1, the scan selection is shifted so that the gate line G4 may be selected by the scan driver 224-1. At this time, the non-selection signal DOFF-1 remains at low level during four periods of the signal CL3, so that the output of the scan driver 224-1 is made effective. As such, the scan selection is executed to select the consecutive four gate lines in sequence. Then, on the rise of the scan timing signal CL3-2, the scan driver 224-2 selects the gate line 385, on the next rise of the signal CL3-2, the scan selection is shifted so that the gate line G386 may be selected by the scan driver 224-2. Likewise, the scan driver 224-2 selects the gate line G387 and G387 sequentially and continuously. At this time, the non-selection signal DOFF-2 remains at low level during four periods of the signal CL3, so that the output of the scan driver 224-2 is effective. Later, likewise, the scan selection is repeated in the sequence of the gates lines G5, G6, G7, G8, G389, G390, G391 and G392. In this case, the light field selection scan A shown in FIG. 30 is executed for the gate lines G1, G2, G3 and G4, while the dark field selection scan B is executed for the gate lines G385, G386, G387 and G388.

As described above, by controlling the frame synchronous signal FLM, the non-selection signals DOFF-1, DOFF-2 and DOFF-3 in synchronous to the scan timing signals CL3-1 to CL3-3 of the scan driver, the light field selection scan A and the dark field selection scan B shown in FIGS. 30, 37 and 39 may be alternately executed every four lines.

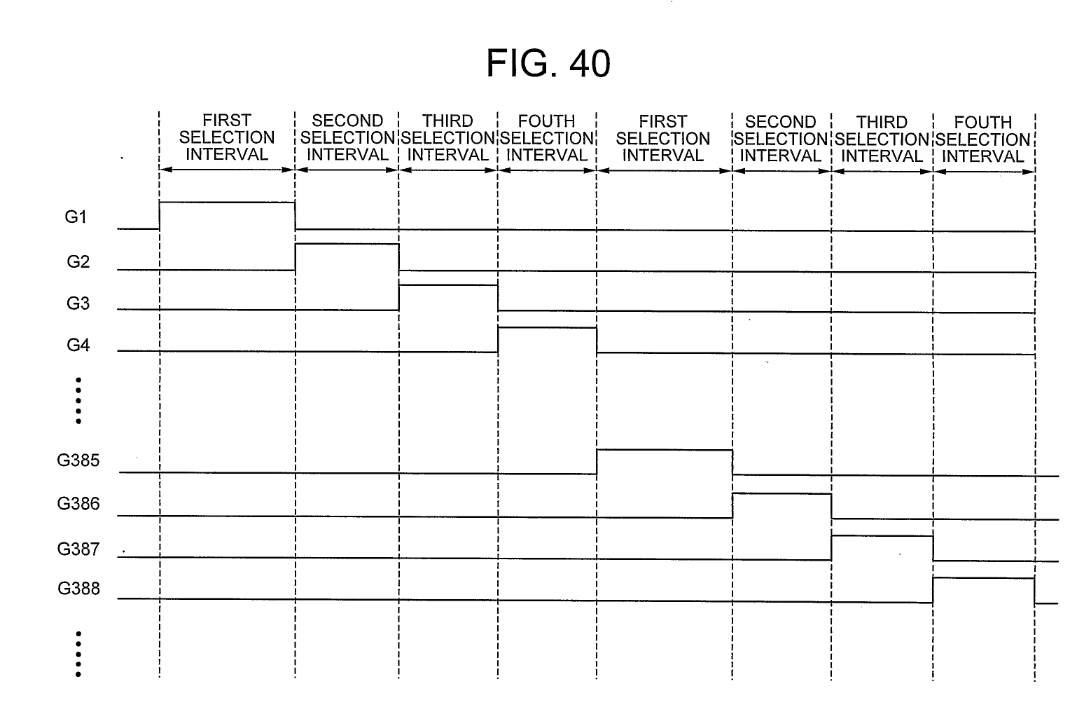

In this embodiment, the scan selection is executed every four lines though it is executed every line in the eighth embodiment. Hence, this scan selection improves the characteristic of applying the liquid crystal drive voltage. FIG. 40 shows the detailed scan selection of the gate lines G1 to G4 and G385 to G388 shown in FIG. 39. The selection interval of four gate lines G1 to G4 or G385 to G388 is made to correspond with the first to the fourth selection intervals, and the first selection interval is arranged to be longer than another selection interval. For example, in the case of selecting the gate line G385, because of the influence of the liquid crystal drive voltage of the previous gate line G1, the applied voltage of the liquid crystal drive voltage of the gate line G385 may be often shifted. This shift appears as a ghost image. Concretely, the display of the gate line G1 dimly appears around the gate line G385. It means that the image quality is degraded. Hence, the first selection interval when the concerned gate line is influenced by the drive voltage of the previous gate line is arranged to be longer than the other second to the fourth selection intervals, thereby reducing the influence of the liquid crystal drive voltage of the previous line and keeping the image quality higher. Like the normal sequential scan selection, in the second to the fourth selection intervals, the previous line is adjacent to the current line. Hence, the liquid crystal drive voltage of the previous line hardly has an adverse influence on the current line. As such, in the ninth embodiment, in the case of executing the scan selection alternately for the light field and the dark field, by executing the scan selection every four lines alternately for the light field and the dark field, it is possible to improve the characteristic of applying the liquid crystal drive voltage onto the liquid crystal display panel and thereby keeping the image quality higher.

This embodiment concerns with the scan selection of four consecutive lines. However, the number of lines is not limited to four. Instead, the scan selection of every plural lines such as two lines or three lines may offer the same effect.

### Tenth Embodiment

In turn, the description will be oriented to the tenth embodiment that is arranged to improve the blurredness of the moving image by changing the ratios of the light field interval and the dark field interval during the frame period.

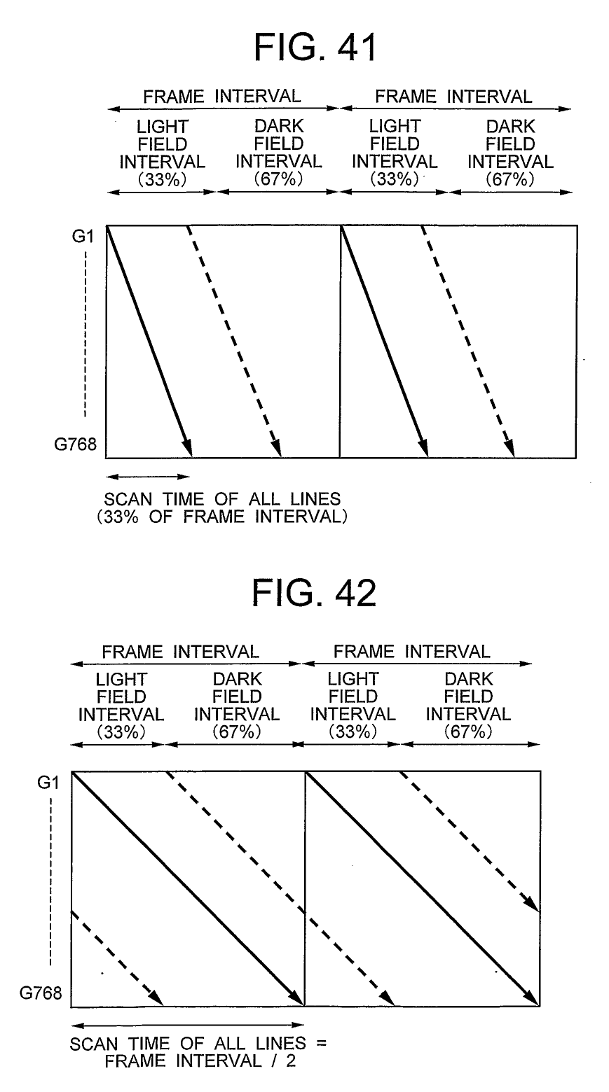

FIG. 41 shows the scan selection to be executed in the case of changing the ratios of the light field interval and the dark field interval in the double-speed scan described with respect to the first to the seventh embodiments from about 50% and 50% to about 33% (about ⅓) (for the ratio of the light field) and about 67% (about ⅔)(for the ratio of the dark field). As such, by making the dark field interval longer, it is possible to enhance the effect of the impulse response and improve the blurredness of the moving image.

FIG. 42 shows the scan selection to be executed alternately for the light field interval and the dark field interval in the case of changing the ratios of the light field interval and the dark field interval from about 50% and 50% as described with respect to Eighth and Ninth embodiments to about 33% (for the light field interval) and about 67% (for the dark field interval). As shown in FIG. 42, as the ratio of the light field interval in a one-frame interval becomes smaller (as the ratio of the dark field interval becomes larger), the lines to which the corresponding voltage with the light field data is applied in the light field interval are made greater in number. (Conversely, the lines to which the corresponding voltage with the dark field data in the light field interval is applied are made smaller in number.) The ratio of the light field interval to the dark field interval is equal to the ratio of the number of lines to which the corresponding voltage with the dark field data is applied in the light field interval to the number of lines to which the corresponding voltage with light field data is applied. Likewise, the ratio of the light field interval to the dark field interval is equal to the ratio of the number of lines to which the corresponding voltage with the light field data is applied in the dark field interval to the number of lines to which the corresponding voltage with the dark field data is applied. As such, by making the dark field interval longer, it is possible to enhance the effect of the impulse response and thereby improve the blurredness of the moving image. The dark field interval is longer than a half frame period but shorter than a one-frame period. It means that the light field interval is longer than zero but shorter than a half frame period.

In the case of FIG. 41, each of the light field and the dark field occupies about 33% of the frame interval in which the scan selection is executed for all the lines. Hence, assuming that a frame interval is 60 Hz, that is, about 16.7 ms, the selection interval per line is derived by the calculation of 16.7 ms×0.33/768 lines=about 7.2 μs. In the case of FIG. 42, on the other hand, the light field and the dark field are alternately selected, so that the interval in which the scan selection is executed for all the lines is made to correspond to about a half of one frame period. Assuming that the frame interval is 60 Hz, that is, about 16.7 ms, the selection interval per line is derived by the calculation of 16.7 ms×0.50/768 lines=about 10.9 μs. That is, in the double-speed scan shown in FIG. 41, if the light field interval is made shorter, the scan selection time of one line is made shorter accordingly. On the other hand, in the alternate scan of the light field and the dark field as shown in FIG. 42, if the light field interval is made shorter, the scan selection time of one line is not changed. Hence, for the alternate scan of the light field and the dark field described with respect to the eighth and the ninth embodiments, even if the light field interval for enhancing the impulse response effect is made shorter, the selection time of one line that influences the characteristic of applying the liquid crystal drive voltage may be made longer, thereby being able to keep the image quality higher with little influence by display unevenness. In addition, the calculation of the selection time of one line does not include the influence of the retrace interval for simplifying the description.

In the eighth, the ninth and the tenth embodiments, the description has been expanded on the assumption that the liquid crystal display panel has a vertical resolution of 768 lines. In actual, the vertical resolution is not limited to the number of lines. Another resolution such as a HDTV resolution of 1920 dots×1080 lines may offer the same effect.

The present invention provides a hold-type display device such as a liquid crystal display device, an organic EL (Electro Luminescence) display or a LCOS (Liquid Crystal On Silicon) display which is arranged to reduce the blurredness of the moving image at low tones. Hence, the present invention may be applied to a TV set, a PC monitor, a portable phone, and a game instrument each provided with a liquid crystal display panel.

It should be further understood by those skilled in the art that although the foregoing description has been made on embodiments of the invention, the invention is not limited thereto and various changes and modifications may be made without departing from the spirit of the invention and the scope of the appended claims.

1. A hold-type display device for holding a display of tones in a one-frame interval, characterized in that:
each pixel displays one tone requested by an external system by displaying a plurality of tones in a one-frame interval; and
in a case that said tone requested by said external system is a halftone between a maximum tone and a minimum tone, at least one of said plural tones in said one-frame interval is lower than said tone requested by said external system.

2. A display device as claimed in claim 1, wherein in a case that said tone requested by said external system is said halftone, at least one of said plural tones in said one-frame interval is said minimum tone.

3. A display device as claimed in claim 2, wherein in a case that said tone requested by said external system is included on a lower tone side of said halftone, at least one of said plural tones in said one-frame interval is said minimum tone, and in a case that said tone requested by said external system is included on a higher tone side of said halftone, at least another one of said plural tones in said one-frame interval is said maximum tone.

4. A display device for displaying the corresponding tone or luminance with display data to be inputted from an external system, comprising:
a display panel having a plurality of pixels arranged in matrix;
a memory for holding display data to be inputted from said external system;
a first and a second converting circuits for converting said display data of a halftone into a different value;
a signal generator circuit for generating a control signal for driving said display panel in response to an input signal sent from said external system;
a first driver for outputting the corresponding voltage with said display data to said pixel; and
a second driver for scanning a pixel to which said voltage is to be supplied; and
wherein said display data is written once in said memory in a one-frame interval and is read twice from said memory in a one-frame interval, said first converting circuit converts the first display data read from said memory at the first time, said second converting circuit converts the second display data read from said memory at the second time, in a case that the display data to be inputted from said external system is a halftone, the luminance derived by said converted second display data is lower than said converted first display data, said second driver scans said pixel twice in a one-frame interval in response to said control signal, and said first driver outputs the corresponding first voltage with said converted first display data to said pixel according to the first scan executed by said second driver and outputs the corresponding second voltage with said converted second display data according to the second scan executed by said second driver.

5. A display device as claimed in claim 4, wherein a polarity of said voltage at each pixel is reversed in each second scan executed by said second driver.

6. A display device as claimed in claim 4, wherein in said each pixel, within an interval of several hundreds seconds, the times when a potential of a positive polarity is applied by said first voltage, the times when a potential of a negative polarity is applied by said first voltage, the times when a potential of a positive polarity is applied by said second voltage, and the times when a potential of a negative polarity is applied by said second voltage are equal to one another.

7. A display device as claimed in claim 4, wherein a conversion set value of said first converting circuit and a conversion set value of said second converting circuit are changed in response to a request sent from said external system.

8. A display device as claimed in claim 4, wherein said first and second converting circuits convert the display data of the current frame interval according to the display data of the one-previous frame interval,
in a case that the display data of said current frame interval is equal to the display data of said one-previous frame interval, the luminance derived by the converted first display data of said current frame interval is equal to or larger than the luminance derived by the converted second display data of said one-previous frame interval, and
said first driver outputs said first and second voltages to said pixel based on the first and second display data converted so that the luminance derived in the case that the display data keeps same in the current frame interval may be kept same irrespective of the display data of said one-previous frame interval.

9. A display device as claimed in claim 4, wherein said first and second converting circuits convert the display data of the current frame interval according to the display data of the one-frame previous interval,
in a case that the luminance derived by the display data of said current frame interval is larger than the luminance derived by the display data of said one-previous frame interval, said first converting circuit makes the converted first display data larger, in a case that the resulting luminance is lower, said second converting circuit makes the converted second display data larger,
in a case that the luminance derived by the display data of said current frame interval is smaller than the luminance of the display data of said one-previous frame interval, said second converting circuit makes the converted second display data smaller, in a case that the resulting luminance is higher, said first converting circuit makes the converted first display data smaller.

10. A display device as claimed in claim 4, wherein any one of said first and second converting circuits converts the display data of the current frame interval according to the display data of the one-previous frame interval.

11. A display device as claimed in claim 4, wherein the interval of selecting the pixel through said second scan of said second driver is longer than the interval of selecting the pixel through said first scan of said second driver.

12. A hold-type display device for holding a display of tones in a one-frame interval, characterized in that:
each pixel displays one tone requested by an external system by displaying two tones in a one-frame interval,
in a case that the tone requested by said external system is included on a lower tone side of a halftone between a maximum tone and a minimum tone, one of two tones in said one-frame interval is said minimum tone and the other of said two tones is changed according to the tone requested by said external system, and
in a case that the tone requested by said external system is included on a higher tone side of said halftone, one of said two tones in said one-frame interval is changed according to the tone requested by said external system, and the other of said two tones is said maximum tone.

13. A display device as claimed in claim 12, wherein in a case that the tone requested by said external system is said maximum tone, both of said two tones in said one-frame interval are said maximum tone.

14. A display device as claimed in claim 12, wherein a border between said lower tone side and said higher tone side of said tone requested by said external system corresponds to a tone obtained by setting one of the two tones in said one-frame interval to said minimum tone and setting the other to said maximum tone.

15. A display device as claimed in claim 12, wherein in a case that flickers resulting from a difference of the luminance between the two tones in said one-frame interval are visually observed, one of said two tones in said one-frame interval is made higher and/or the other thereof in said one-frame interval is made lower.

16. A hold-type display device for holding a display of a one-frame tone, characterized in that:
each pixel displays one tone requested by an external system by displaying two tones in a one-frame interval, and
in a case that a difference of a luminance between the two tones in a one-frame interval is equal to or lower than a luminance of a tone requested by said external system, one of said two tones in said one-frame is made as low as possible.

17. A display device for displaying the corresponding tone or luminance with display data to be inputted from an external system, comprising:
a display panel having a plurality of pixels arranged in matrix;
a memory for holding display data to be inputted from said external system;
a converting circuit for converting said display data into first and second display data;
a first driver for outputting the corresponding voltage with said display data onto said pixels; and
a second driver for scanning lines of said pixels to which said voltage is to be supplied; and
wherein in a case that said display data to be inputted from said external system is a halftone, a tone or a luminance of any one of said first and second display data is higher than a tone or a luminance of said display data to be inputted from said external system and a tone or a luminance of the other display data is lower than a tone or a luminance of said display data to be inputted from said external system, and
said second driver sequentially selects a first n line(s) (n being an integer of 1 or more) adjacent to each other as lines of the pixels to which the corresponding first voltage with said first display data is to be supplied in a one-line-by-one-line manner, and selects a second n lines adjacent to each other and being spaced from said first n line(s) by an interval of m lines (m being an integer of 2 or more) as lines of the pixels to which the corresponding second voltage with said second display data is to be supplied in a one-line-by-one-line manner, also selects a third n line(s) adjacent to each other and being spaced by an interval of m lines from said second n line(s) as lines of the pixels to which the corresponding first voltage with said first display data is to be supplied in a one-line-by-one-line manner, further selects a fourth n lines adjacent to each other and being spaced by an interval of m lines from said third n line(s) as lines of the pixels to which the corresponding second voltage with said second display data is to be supplied in a one-line-by-one-line manner, and so forth.

18. A display device as claimed in claim 17, wherein said n is 1, 2 or 4.

19. A display device as claimed in claim 17, further comprising a frame memory for holding display data of a one-previous frame, and wherein said first converting circuit converts the display data to be inputted from said external system into first display data based on relation between said display data to be inputted from said external system and said display data of a one-previous frame read from said frame memory, and
said second converting circuit outputs to said pixels a voltage on which said display data read from said memory is converted into said second display based on relation between the display data read from said memory and the display data of the one-previous frame read from said frame memory.

20. A display device as claimed in claim 17, wherein a speed at which the corresponding tone or luminance with said first display data and the corresponding tone or luminance with said second display data is displayed on said display panel is higher than a speed at which said display data is inputted from said external system.

21. A display device as claimed in claim 17, wherein said second driver alternately repeats selection of the first group of lines of pixels of said display panel and selection of the second group of lines of pixels of said display panel in a first period of a one-frame interval and alternately repeats selection of the first group of lines of pixels of said display panel and selection of the second group of lines of pixels of said display panel in a second period of said one-frame interval,
said first driver outputs the corresponding first voltage with said first display data in a case that said second driver selects said first group in said first period, outputs the corresponding second voltage with said second display data in a case that said second driver selects said second group in said first period, outputs the corresponding second voltage with said second display data in a case that said second driver selects said first group in said second period, and outputs the corresponding first voltage with said first display data in a case that said second driver selects said first group in said second period,
said first group includes said first n line(s) and said third n line(s), and
said second group includes said second n line(s) and said fourth n line(s).

22. A display device for displaying the corresponding tone with display data to be inputted from an external system, comprising:
a display panel having a plurality of pixels arranged in matrix;
a memory for holding said display data to be inputted from said external system;
a converting circuit for converting said display data into first display data and second display data;
a first driver for outputting the corresponding voltage with said display data to said pixels; and
a second driver for scanning lines of pixels to which said voltage is to be supplied; and
wherein in a case that said display data to be inputted from said external system is a halftone, a tone or a luminance of any one of said first and second display data is higher than a tone or a luminance of said display data to be inputted from said external system and a tone or a luminance of the other display data is lower than a tone or a luminance of said display data to be inputted from said external system,
a one-frame interval includes a first period and a second period,
said lines of pixels of said display panel includes a first group having N (N being an integer of 2 or more but less than the number of all the lines of said display panel) lines and M (M being an integer of 2 or more but less than the number of all the lines of said display panel) lines,
said second driver alternately repeats a scan for every n (n being an integer of 1 or more but less than said N) lines of the N lines of said first group and a scan for m (m being an integer of 1 or more but less than said M) lines of the M lines of said second group in said first period, for scanning said first and second groups, and alternately repeats a scan for every n lines of the N lines of said first group and a scan for every m lines of the M lines of said second group in said second period, for scanning said first and second groups, and
said first driver outputs the corresponding first voltage with said first display data in a case that said second driver scans said first group in said first period, outputs the corresponding second voltage with said second display data in a case that said second driver scans said second group in said first period, outputs the corresponding second voltage with said second display data in a case that the second driver scans said first group in said second period, and outputs the corresponding first voltage with said first display data in a case that said second driver scans said first group in said second period.

23. A display device as claimed in claim 22, wherein said second driver sequentially selects the lines included in said n lines one line by one line for scanning said n lines and sequentially selects the lines included in said m lines one line by one line for scanning said m lines.

24. A display device as claimed in claim 22, wherein said n is equal to said m and said n and said m are 1, 2, 3 or 4.

25. A display device as claimed in claim 22, wherein said N is a half of all the lines of said display panel and said M is a half of all the lines of said display panel.

26. A display device as claimed in claim 22, wherein the length of said first period is different from the length of said second period.

27. A display device as claimed in claim 26, wherein said N is different from said M.

28. A display device as claimed in claim 27, wherein a ratio of the length of said first period to the length of said second period is equal to a ratio of said M to said N.
